(19) United States
(12) Patent Application Publication
(10) Pub. No.: US 2026/0057099 A1
(43) Pub. Date: Feb. 26, 2026

(54) SYSTEMS AND METHODS FOR SECURE AI QUERY ASSISTED SUPPLY CHAIN OPTIMIZATION

(71) Applicant: OII, INC., Oakland, CA (US)

(72) Inventor: Robert Derward Rogers, Oakland, CA (US)

(21) Appl. No.: 19/308,797

(22) Filed: Aug. 25, 2025

Related U.S. Application Data
(60) Provisional application No. 63/687,304, filed on Aug. 26, 2024.

(51) Int. Cl. G06F 21/62; G06F 16/2452

(52) U.S. Cl. CPC G06F 21/6227; G06F 16/2452

(57) ABSTRACT

The present invention relates to systems and methods for query-based analysis of optimization of a supply chain. In some embodiments, a query is received within a trusted environment of an optimization system, wherein the query includes a natural language expression. The query is supplied to an Artificial Intelligence (AI) transformation system, wherein the AI transformation system converts the query into a function and parameter statement. The function and parameter statement are translated into at least one API call and function, which are executed to generate results. The results are then outputted. The AI transformation system is locally trained on the optimization system. In some embodiments, the query may be augmented with information. The information includes at least one of query source information and query intent information. Additionally, sensitive data in the query may be identified. The sensitive information is identified by blacklist, whitelist or semantic analysis.

### CROSS REFERENCE TO RELATED APPLICATIONS

This application claims the benefit and is a non-provisional application of U.S. Provisional Patent Application No. 63/687,304 filed August 26, 2024 entitled “SYSTEMS AND METHODS FOR SECURE AI QUERY ASSISTED SUPPLY CHAIN OPTIMIZATION”, which application is incorporated in its entirety by this reference.

### BACKGROUND

The present invention relates to systems and methods for supply chain optimizations leveraging AI queries in a secure manner.

Configuring a supply chain planning system correctly is a complex task and one that most planning systems do not address. Identifying and configuring the optimal supply chain requires multivariate mathematical and a near infinity of potential settings, despite this supply chains typically are configured manually. Supply chain planning systems rely on Planners to set the right parameters even though failure to find the optimal parameters results in ineffective plans that will propagate across the network, regardless of the effectiveness of the software.

It is a significant problem to rely upon a planner for supply chain management because finding the right configuration - even in relatively simple supply chains - is extremely difficult to achieve. There are simply too many variables to consider and multitude of potential service versus cost outcomes. In addition, real-world supply chains are often global, making the task exponentially more complicated. Even for experienced planners this is an insurmountable challenge.

As a result, many supply chains are set up and planned in a significantly suboptimal way, resulting in a combination of issues such as Service Failures and Missed Sales, Overstocks on some items and under-stock on others, Factory Inefficiencies, Reactive rather than Strategic Plans, and High Costs of Waste (for example when products expire while in inventory).

Identifying an optimal set up requires detailed evaluation of the cost versus service implications of the millions of potential configuration options across the end-to-end supply chain network encompassing dimensions such as Supply Chain Variability, Network Design, Product segmentation, Inventory Strategy, Factory sequence and rhythm.

Artificial Intelligence and machine learning techniques (AI/ML) are a new generation of algorithms that demonstrate self-learning and the capability to make decisions. Its power is its ability to process multiple data inputs simultaneously and to use this information to compare outcomes, make informed choices and to self-correct so that those choices improve over time.

In addition to determining a local optimization of a supply chain, different planners, industries and companies may have varying concerns and priorities. It is helpful to be able to model out “what-if” scenarios to address these concerns. However, for a typical planner, who lacks expertise in software programming and configuration, easily testing these “what-if” scenarios may be difficult. Again, here AI platforms may be leveraged, particularly using foundational models, to assist in the querying of specific scenarios. The present systems may bifurcate the foundational model(s) form the underlying optimization platform in order to achieve heightened security and enhanced confidentiality.

It is therefore apparent that there is an urgent need to perform sophisticated AI driven supply chain optimizations responsive to natural language queries in a secure manner. Such systems and methods allow planners to alter supply chain priorities, and model out concerns that may impact future supply chain situations.

### SUMMARY

To achieve the foregoing and in accordance with the present invention, systems and methods for secure AI querying of a supply chain optimization is provided. Such systems and methods allow planners to model and pressure test scenarios where different priorities to the supply chain are made, in a secure and confidential manner.

In some embodiments, a query is received within a trusted environment of an optimization system, wherein the query includes a natural language expression. The query is supplied to an Artificial Intelligence (AI) transformation system, wherein the AI transformation system converts the query into a function and parameter statement. The function and parameter statement are translated into at least one API call and function, which are executed to generate results. The results are then outputted.

The AI transformation system is locally trained on the optimization system. In some embodiments, the query may be augmented with information. The information includes at least one of query source information and query intent information. Additionally, sensitive data in the query may be identified. The sensitive information is identified by blacklist, whitelist or semantic analysis.

In some embodiments, at the optimization system, the sensitive information may be replaced with a synthetic placeholder prior to sending the query to the AI transformation system. In these cases, the sensitive information may be reintegrated into the function and parameter statement in the optimization system. In some embodiments, the AI transformation system includes a foundational model, and the at least one API call and function includes a hypothetical supply chain optimization.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

In order that the present invention may be more clearly ascertained, some embodiments will now be described, by way of example, with reference to the accompanying drawings, in which:

FIG. 1 is a block diagram illustrating an Orchestrated Intelligent Supply Chain Ecosystem, in accordance with one embodiment of the present invention;

FIG. 2 is a block diagram illustrating one embodiment of an Optimizer for the Ecosystem of FIG. 1;

FIG. 3 is a block diagram illustrating an example of the hypothetical scenario module, in accordance with some embodiments;

FIG. 4 is a block diagram illustrating an example of the optimization module, in accordance with some embodiments;

FIG. 5 is a block diagram illustrating an example of the performance prediction module, in accordance with some embodiments;

FIG. 6 is a block diagram illustrating an example of the optimized parameters and sensitivities computation module, in accordance with some embodiments;

FIG. 7 is a block diagram illustrating an example of the system for a secure AI query analysis of a supply optimization, in accordance with some embodiments;

FIG. 8 is a flow diagrams illustrating an example process of natural language query analysis of an optimization;

FIG. 9 is a flow diagrams illustrating an example sub-process of query sanitization and augmentation;

FIG. 10 is a flow diagrams illustrating an example sub-process of generating actions from the augmented query;

FIG. 11 is a flow diagrams illustrating an example sub-process of value restoration;

FIG. 12 is a flow diagrams illustrating an example sub-process of performing optimization functions;

FIG. 13 is an illustration of an example informational flow between the user, the optimization system and a foundational AI model; and

FIGS. 14A and 14B illustrate an exemplary computer system for implementing the supply chain optimization system.

### DETAILED DESCRIPTION

The present invention will now be described in detail with reference to several embodiments thereof as illustrated in the accompanying drawings. In the following description, numerous specific details are set forth in order to provide a thorough understanding of embodiments of the present invention. It will be apparent, however, to one skilled in the art, that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

Aspects, features and advantages of exemplary embodiments of the present invention will become better understood with regard to the following description in connection with the accompanying drawing(s). It should be apparent to those skilled in the art that the described embodiments of the present invention provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the present invention as defined herein and equivalents thereto. Hence, use of absolute and/or sequential terms, such as, for example, “always,” “will,” “will not,” “shall,” “shall not,” “must,” “must not,” “first,” “initially,” “next,” “subsequently,” “before,” “after,” “lastly,” and “finally,” are not meant to limit the scope of the present invention as the embodiments disclosed herein are merely exemplary.

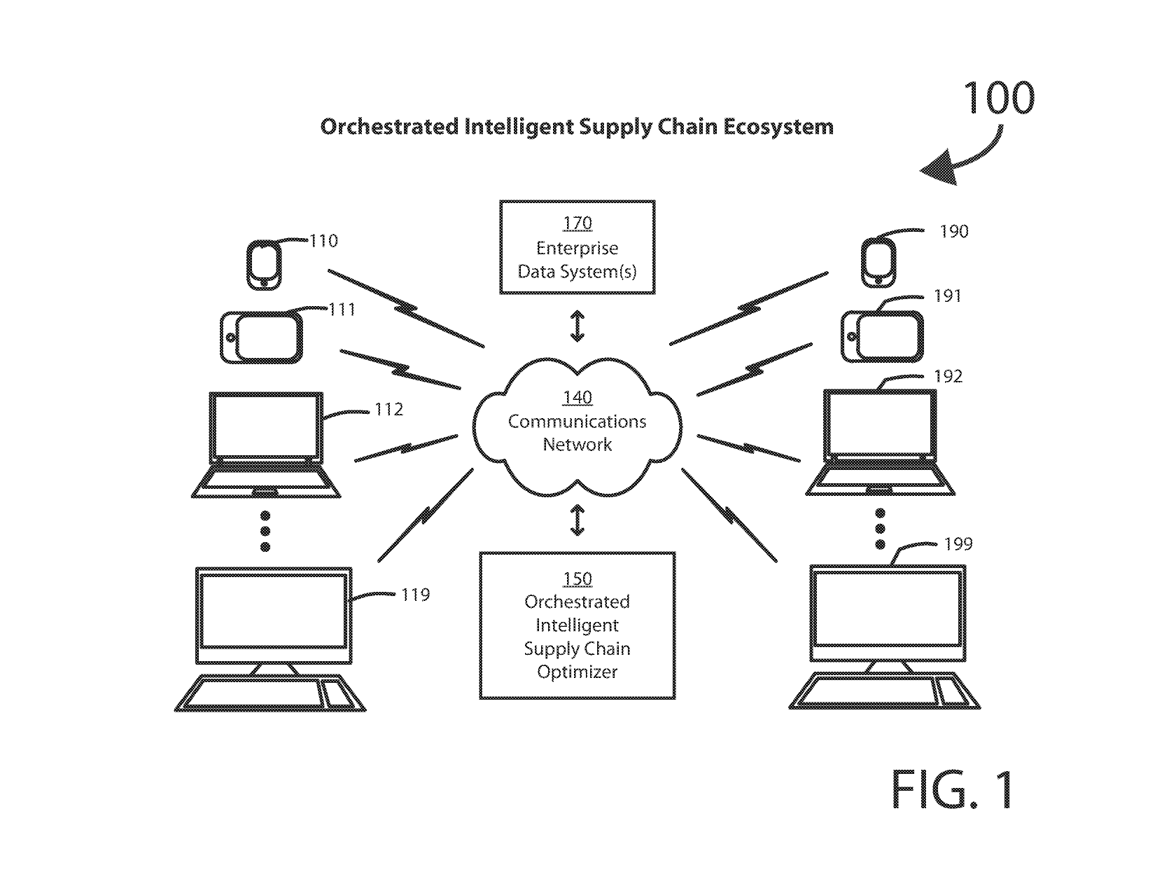

The present invention relates to systems and methods for running hypothetical scenarios in an intelligent optimized supply chain responsive to a natural language query that is processed vis a foundational model. To facilitate discussion, FIG. 1 is a block diagram of an Orchestrated Intelligent Supply Chain Ecosystem 100 illustrating an Orchestrated Intelligent Supply Chain Optimizer 150 coupled to Enterprise Data System(s) 170 and stakeholders’ communication devices 110 to 119 and 190 to 199 via a communication network 140 such as the Internet, wide area network, cellular network, corporate network, or some combination thereof. Depending on the implementation, exemplary stakeholders can include one or more groups of managers (including, but not limited to, operations managers, supply chain managers, IT managers), planners, data scientists, data miners, data engineers, data providers, manufacturers, distributors, and retailers.

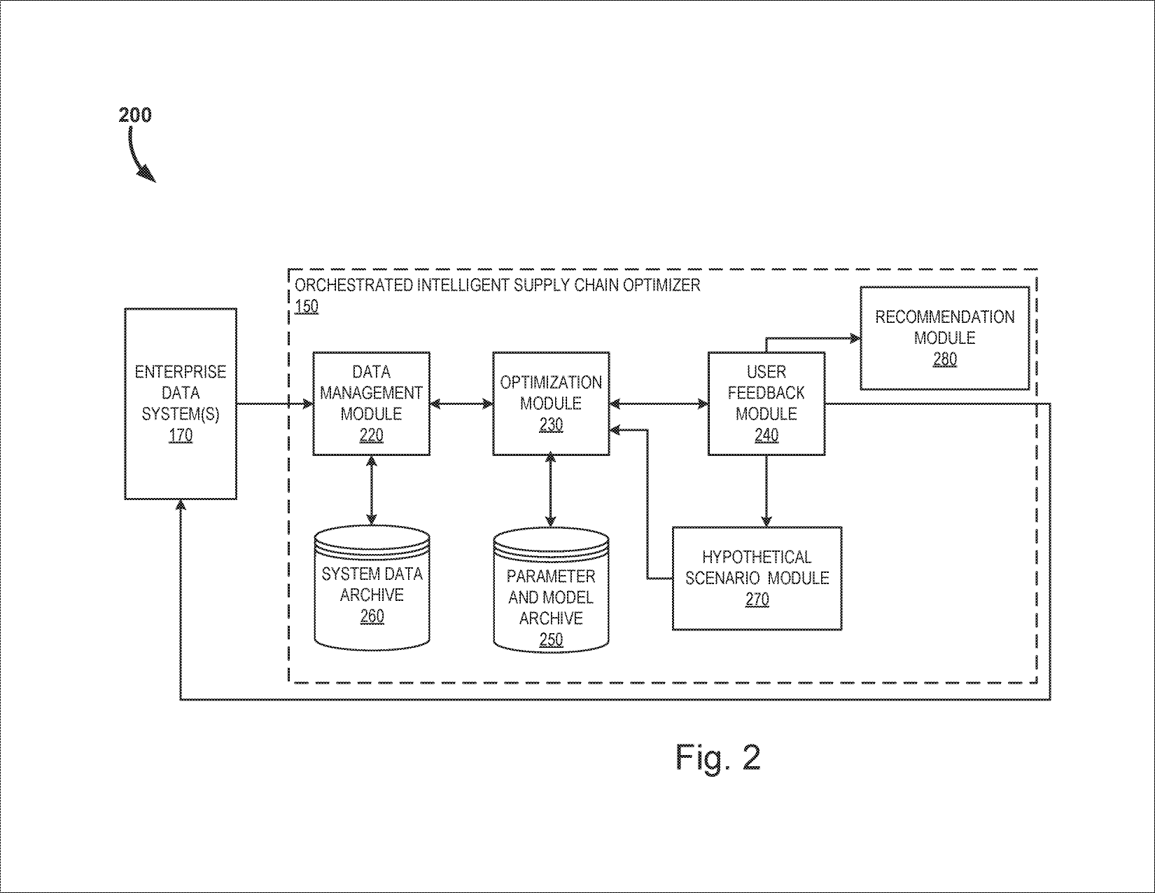

The core of the supply chain optimizer 150 is presented in greater detail in reference to FIG. 2. The enterprise data systems 170 from various third-party entities who are seeking supply chain optimization (commonly referred to as “clients” or “customers”) provides information regarding the client’s existing supply chain to the optimizer 150. This data is initially provided to the data management module 220 for ingestion. The data provided from the enterprise data system(s) 170 is in an unusable form for the downstream optimization module 230. Generally, each client has different outputs of their supply chain data based upon the backend system (or systems) they employ, and due to personalization and customizations to the data format and content. This creates a significant hurdle for the supply chain optimizer 150 ultimate usage of the client’s data. The data management module 220 solves these issues through complicated AI-driven data ingestion techniques. The Data Management Module 220 configures connections to data from customer enterprise data systems (EDS) and receives these data in both asynchronous processes (batch data import) and synchronous processes (ongoing/live data feeds). These data are then combined with any system data previously stored in System Data Archive 260 to create a representation of the supply chain network. This data is of four distinct types (examples are not exhaustive): Item Master Data (fixed data related to the item): code, description, price, UOM etc.; Item Parameter Data which determines how the network is currently planned. Examples are Current Safety Stock Levels, Delivery Frequency, Order Multiples; Supply Chain Variability data- Examples are product-level monthly demand history, delivery performance history or characteristics; Strategic Objective Parameters/ Constraints such as Service Targets, Site sensitivity to complexity, cost of holding stock, Transport Costs etc.

After the data has been ingested by the data management module 220, copies of relevant formatted data are stored in the system data archive 260. The system data archive includes a myriad of necessary data, including historical demand data, historical forecast data, historical inventory levels at different locations (nodes) in the supply chain for different products, supply chain site information, supply chain product information, information on linkages between sites including transport times, transport time variability, transport methods and costs, supply chain configuration parameters (e.g. replenishment strategies and the parameters for each strategy at each location for each product), product cost of goods sold (“COGS”), product retail or list price at each location, factory changeover costs, carbon emission by different components of the supply chain, service level targets, market segmentation for products, among many others.

The optimization module 230 performs the heavy lifting of the optimization process. It consumes the cleansed, formatted and aggregated data from the data management module 220 and performs the optimization of the supply chain, leveraging AI/ML models, subject to specific constraints. These constraints, models, and other parameters are stored in a parameter and model archive 250. As the models are developed, implemented, and feedback is received- the models may be trained on said feedback. The updated models are then stored, typically in a versioned manner, back in the parameter and model archive 250 for subsequent usage.

Output of the optimization module 230 is generally fed to the user feedback module 240 for presentation of the results, and importantly, pushing the recommendations to the enterprise data system 170 of relevance for implementation of the recommendations through a recommendation module 280. The recommendation module 280 may filter results of various hypothetical scenarios that have been optimized for (discussed in significant detail below) and identify scenarios that have statistically significant impact upon service levels, costs, or risks (e.g., freshness of product, reduced stockout risk, etc.). For the purposes of this disclosure, ‘statistically significant’ may refer to a change in the values above 10%, or above 0.2 standard deviations. In contrast, ‘roughly statistically significant’ may be above 5% and 0.1 standard deviations.

This results in a feedback loop, where the resulting impacts of the adopted recommendations are fed back into the system, and the models may be refined based upon the actual impacts measured (vs the modeled/expected impacts). With improved models, and changes in conditions, the process repeats with optimization and output.

In addition to pushing the recommendations to the client, the user feedback model 240 is able to provide analysis of the actual impacts of the supply chain (e.g., cost, service levels, inventory levels per node, changeover events, etc.) versus what is expected based upon the optimized parameters. This enables the client to visualize and react to the optimized conditions, and in some embodiments, engage in modulating possible parameters in order to analyze the possible impacts.

Input from a user via the feedback module 240 may be fed into a hypothetical scenario module 270 which consumes the query by the user for a “what-if” scenario and converts the query into a set of optimization parameters. These parameters are fed into the optimization module 230 for processing to generate outputs regarding the ‘best’ supply chain configurations for the given hypothetical scenario. These outputs are again fed to the user feedback module for presentation to the user, and generation of possible recommendations by the recommendation module 280.

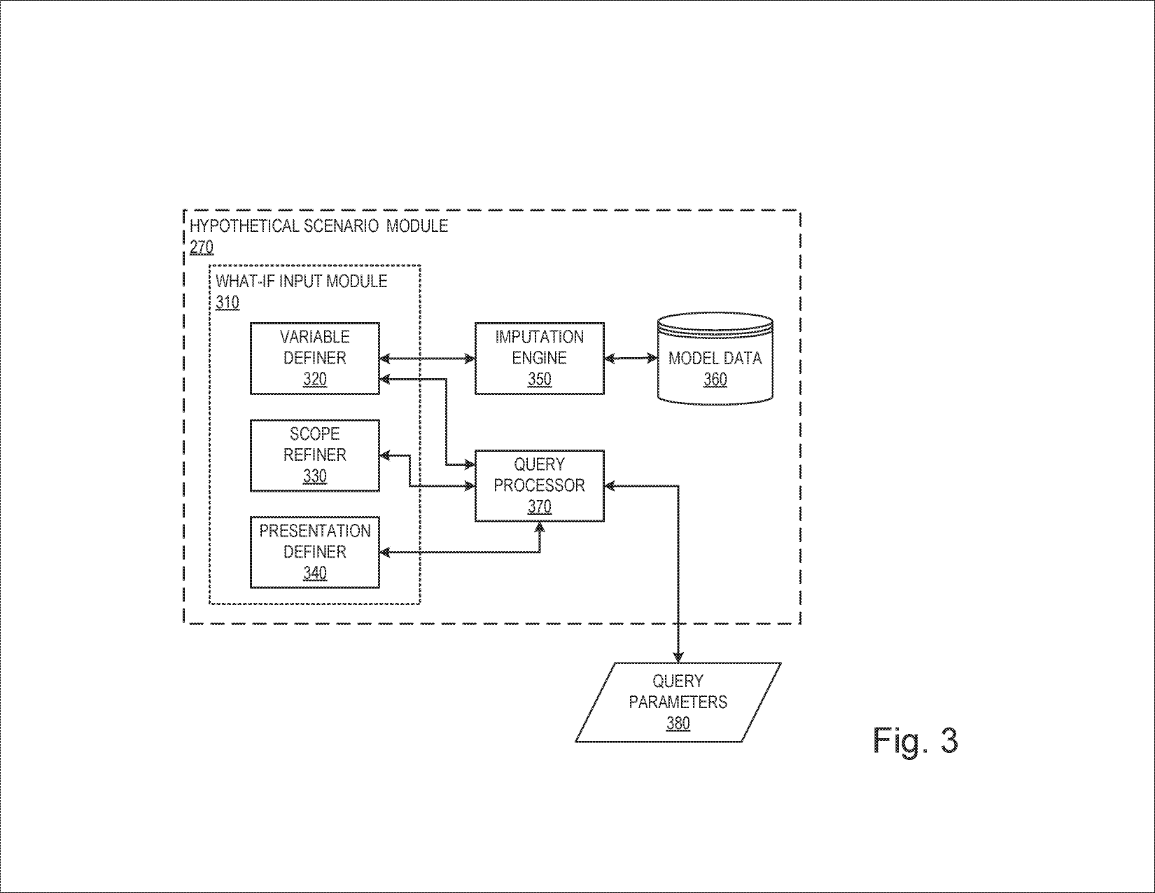

FIG. 3 provides a more detailed illustration of the hypothetical scenario module 270. Initially a query is received from the feedback module 240. This query may be an alteration of specific optimization inputs or may include a natural language query via a foundational AI modeling system, as will be discussed in greater detail below. For example, a user could select to increase the weight of a carbon cost by 3 times (alteration of the specific optimization input), or could ask the system “what if we increased the cost of carbon emissions by 300 percent?” (a natural language query).

The query then undergoes three stages of analysis to generate an optimization parameter set. These include defining the variables of the optimization in the variable definer 320, refining the scope of the optimization at the scope refiner 330, and while not directly related to the optimization itself, the presentation definer 340 may take input from the user to provide the display of the resulting optimization. In alternate embodiments, the presentation definer 340 may take the results of the what-if optimization and determine which presentations are best suited for the results.

The variable definer 320 generally can alter different optimization input variables without additional data; however, in some more complex hypotheticals, unknown values are required for the generation of the optimization parameter set. For these situations, imputation engine 350 may leverage existing model data 360 to impute missing data. Confidence in the imputation may also be calculated by the imputation engine 350, which is used in downstream analysis as to the veracity of the hypothetical results. After any imputation step, a human may be requested to review imputation results to confirm or reject the imputation results. In some embodiments the imputation may generate three (or some other manageable number) of desired scenarios/recommendations. The user may then select from the recommendations the ‘best’ solution given their specific query. This feedback may be utilized in turn to train the machine learning algorithms.

The output of the variable definer 320 and the scope refiner 330 is compiled by the query processor 370 to generate a set of query parameters 380. These query parameters 380 are a set of optimization parameters and constraints that are consumed by the optimization engine for the processing of the hypothetical scenario.

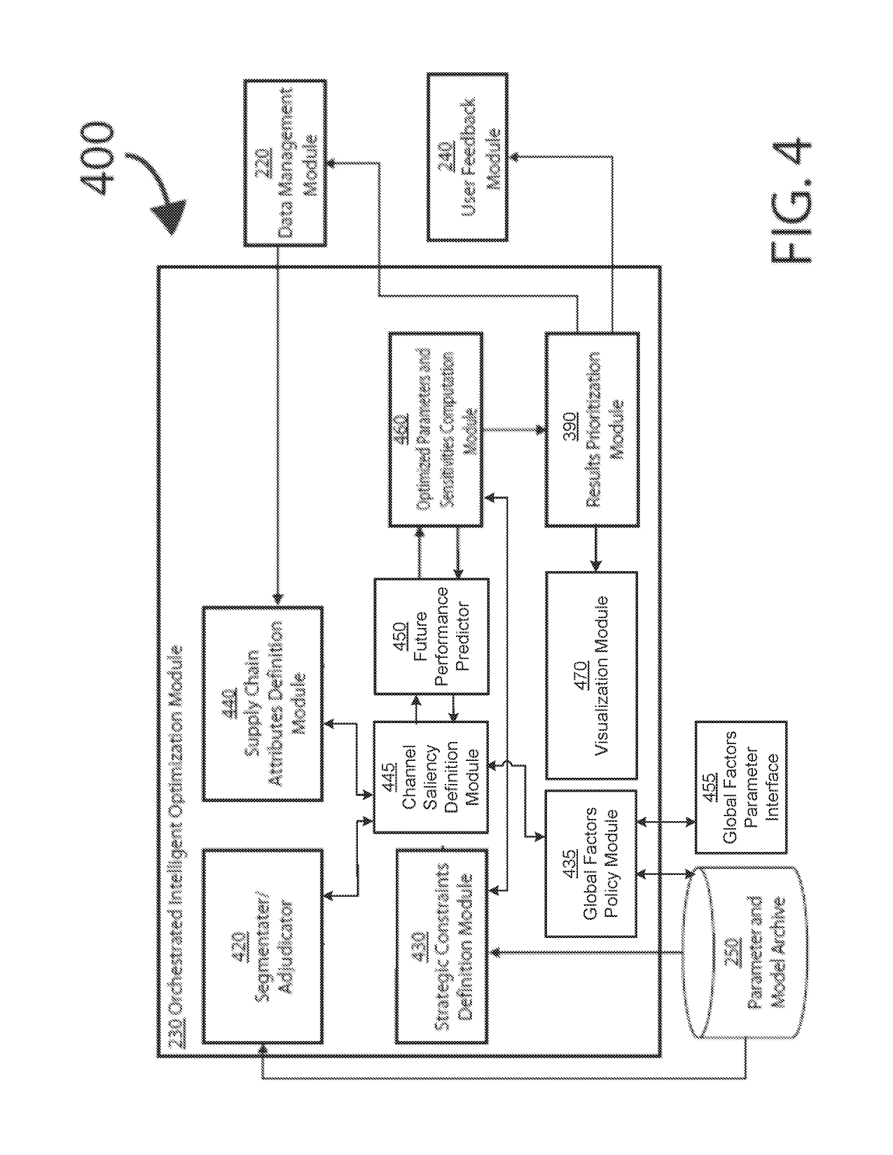

Turning to FIG. 4, a more detailed illustration of the optimization module 230 is provided. In a Global Factors Parameter Interface 455, external inputs to Global Factors are retrieved and made available to the Orchestrated Intelligent Supply Chain Ecosystem 100. These external inputs can include, but are not limited to, the types of carbon tax, carbon exchange trading systems and voluntary carbon offset programs that the customer is enrolled in along with parameters that determine their impacts on the customer. One important example of such parameters is cost data for carbon offsets retrieved from live systems (which may include online marketplaces, transaction exchanges, live bidding markets, or external price lists and interfaces) which can be used to compute accurate cost impacts of choices of supply chain configuration, and in some cases even execute transactions to lock in these sources at the time they are needed to offset supply chain activity.

Sensitivity results from Optimized Parameters and Sensitivities Computation Module 460 which identify sensitivity of optimization results to variability in system attributes (for example, increased probability of stockout as a result of decreased delivery performance in a specific part of the network) are presented to users of the Data Management Module 220 to inform Data Management activities. In the example given above (stockout as a function of delivery performance) this capability would identify the need to measure delivery performance more accurately, improve delivery performance in a specific part of the network, or both.

When the permissions of the logged-in users do not allow access to view or change some data in the Orchestrated Intelligent Supply Chain Ecosystem 100 appropriate selection and filtering of data may be performed in this module.

In some embodiments, the Data Management Module 220 tracks ongoing differences between the parameters that were recommended by the OI system at the time of the last parameter export and the parameters deployed in the system of record (imported through customer database). This process of creating a baseline at each export, updating supply chain characteristics such as total cost, total inventory, end-to-end supply chain throughput and lead time variability (all of which may be broken down in a number of ways including by network, subnetwork, node, region, leafSKU, productSKU, product family, among many others) and updating recommended parameters upon data export represents critical functionality for supply chain managers and organizational leaders. In some embodiments these data are represented in tabular and graphical forms in the OI user interface.

In Optimization Module 230, the primary optimization and analysis functions of the Orchestrated Intelligent Supply Chain Optimizer 150 are executed. This module receives data from the Data Management Module 220 and from 250 Parameter and Model Archive. It also interacts with the user to input/update strategic objective parameters and constraints that are used to inform the tradeoffs and cost function used in the optimization process.

While Item Master, Item Parameter and Variability data is set and unchanging based on imports (using the most up to date information in 220) Strategic Objective Parameters/ Constraints are defined by the user as a driver of the way the optimization process works influencing sensitivity of the model to particular goals and constraints and enabling a level of interactive-ness in the modelling process.

Several analytical processes are performed in Optimization Module 230, including segmentation of products based on most recent available data and adjudication of updated segmentation with previous segmentation results, determination of current supply chain network (which in some embodiments includes use of machine learning and AI models to recommend improvements upon an existing network and facilitate implementation of these improvements, a.k.a. AI-augmented network design optimization), prediction of future performance of the supply chain network for different supply chain parameter settings based on a variety of supply chain network configuration assumptions, analysis of optimal supply chain parameter settings given both strategic objectives (e.g. desired Service Levels (SL) for individual products or groups of products) and system-level constraints (e.g. upper limits of the number of orders a supply site can service per time period), and optimization of the presentation of results to planners and other users (in some embodiments, machine learning and/or AI models are used to recommend contents and display parameters of supply chain optimization results).

Optimization Module 230 records results of the various computations (AI-augmented network design optimization) along with user parameter selections and other computational results (e.g., cost and performance implications of choosing non-optimal parameters) in 250 Parameter and Model Archive.

Optimization Module 230 presents the optimized results to users in the User Feedback Module 240 where users (e.g., planners) interact with these results, and the results of such interactions are then transmitted back to the Optimization Module 230 as part of the Machine Learning process driving further optimization of the ML and AI models used by the module. The data is archived so that past decisions can be restored.

User Feedback Module 240 receives results from the Optimization Module 230 that have been conditioned for optimal usefulness and impact. The user may interact with these results in a number of ways, including but not limited to accepting the recommended parameters, modifying the recommended parameters, rejecting the recommended parameters, commenting on results, initiating requests and actions based on the results (for example, a request to modify a network or system constraint, or change a Service Level value for one or more products or segments) and submitting and/or exporting results to the planning system for implementation. Feedback, responses, comments, requests and other input from users are sent back to the Optimization Module 230 for further processing. In some embodiments, feedback, responses, requests and other input from users are sent to other customer systems outside the Orchestrated Intelligent Supply Chain Optimizer 150 as well.

The Parameter and Model Archive 250 acts as a system for storage and retrieval of information relating to the optimization and feedback process, including but not limited to: information relating to past and current model parameters, model designs, user inputs, system settings, supply chain network optimizations, recommendations and changes, intermediate computational results, computed implications of user decisions and inputs, and in some embodiments external inputs to the network design process generated by machine learning and AI systems operating on data external to the system (e.g. financial projections, news articles about markets, companies and products, social media, etc.). This archive acts as a system of record for which parameters values were recommended by the Orchestrated Intelligent Supply Chain Optimizer 150 and which values were actually put into operation by planners. As such it enables the Orchestrated Intelligent Supply Chain Optimizer 150 to both model the optimal supply chain configuration but to also monitor compliance with the recommendations to flag where failure to comply resulted in costs/ issues. It also enables utilization of past results versus actuals as a means to facilitate the self-learning aspect of the ML model such that future configurations improve as the model gains more insight on what decisions drive the best outcomes.

FIG. 4 further illustrates the functionality of Orchestrated Intelligent Optimization Module 230 in greater detail. The primary function of the Segmenter/Adjudicator 420 is to apply grouping logic to products in order to facilitate the supply chain optimization process. In some embodiments, this may be an auto-segmenter that allows the data to automatically identify and suggest a segmentation scheme for the products in the supply chain. There can be multiple simultaneous segmentations or groupings in use at any time, which may have a variety of purposes. For example, products might be organized into classes based on two parameters: their financial value to the organization (e.g., annual revenue) and the variability of demand for the product (e.g. coefficient of variance or CoV). Products in different classes may be managed under different strategies, each of which implies different choices for supply chain parameters and stock ordering methodology (e.g., make-to-stock or make-to-order). These choices then directly influence the prediction and optimization strategies employed in Orchestrated Intelligent Supply Chain Optimizer 150. Another example of segmentation that could impact optimization results is a product type, for example drugs for oncology, HIV and hepatitis might be grouped together into three classes according to their intended uses. In some embodiments, such groupings might directly determine minimum Service Level values for products in each group. Because multiple segmentation or grouping mappings may be used simultaneously, there is also envisioned additional algorithmic structure that can harmonize among different groupings to ensure that ultimately product segmentation or grouping assignments are unique, thus ensuring that parameter assignments are also unique.

In some embodiments, the Segmenter/Adjudicator 420 module might assign groupings following a variety of methodologies. For example, in some embodiments, segmentation may be determined by the customer and passed directly to the system as a product-level attribute or as a mapping or other algorithmic formulation. In other embodiments, segmentation might be computed from data available to the system (product attributes from Data Management Module 220, for example, or information inferred from structured and unstructured sources outside of the customer system, such as text from web sites, healthcare documents, competitive or market analysis reports, or social media). In some embodiments, machine learning and AI may be used to directly construct useful segmentation strategies (for example using clustering algorithms or dimensionality reduction algorithms such as Latent Dirichlet Allocation).

The segmentation activities performed in Segmenter/Adjudicator 420 may be performed periodically (timing could be ad hoc or on a specific cadence, and timing could depend on the specific segmentation algorithm being applied) to ensure that segmentation or grouping of each product is still appropriate to the current conditions. For example, if segmentation depends upon product CoV and the measured product CoV has changed for any reason over time, then it is important for the system to detect this situation and alert the customer.

This is where the Adjudication function of Segmenter/Adjudicator 420 is performed. At any time, an appropriately permissioned user of the system might override the recommended segmentation or grouping of a specific product and set parameters manually. Additionally, when the assigned segmentation or grouping of a product changes over time, such a user may choose to accept or override the newly computed grouping. Adjudication allows users to visualize segmentation or grouping assignments and to assign new values as underlying data or corporate strategies evolve.

The Strategic Parameters and Constraints Definition Module 430 module allows the user to identify constraints on allowed supply chain configurations to ensure compliance with both physical limitations of systems and corporate governance and strategy. For example, without constraints, the Optimized Parameters and Sensitivities Computation Module 460 module might find optimal supply chain parameters settings for products individually, without any regard for the system-wide implications of such settings. As a specific example of this, individual product-level optimization may imply a very large number of frequent reorders of a group of products that are being manufactured by a specific supply site. It may not be physically possible or financially feasible for this supply site to service such a large number of reorder requests (which generally imply reconfiguring the actual manufacturing systems among many other effects), so a constraint limiting the total number of orders to a supply site would need to be included in the computations carried out by the Optimized Parameters and Sensitivities Computation Module 460. Other examples are high transportation costs on particular Supply Customer routings, Pallet spacing in a warehouse and the impact of bulky items on such a modelling outcome.

Other strategic constraints might express business imperatives, such as reducing overall inventory in parts of the supply chain or ensuring that the risk of a stockout of a critical product or group of products be below a specific level.

In many cases. supply constraints can impact many different supply chains simultaneously, creating a need to define global strategic Parameters and Constraints optimization of multiple products simultaneously in Strategic Parameters Definition Module 430. These global strategic parameter are used to regulate the application of Channel saliency values to define the optimal allocation of products across the different coupled markets and supply chains.

The Global Factors Policy Module 435 allows the user to configure the inputs, computations, and outputs required to satisfy the user’s Global Factors Policy. Global Factors refer to all impacts of the supply chain that are not directly part of traditional supply chain costing and logistics activities. Global Factors can have both internal (internal to customer) and external impacts. An example of a Global Factor is environmental impact of the operations defined within the supply chain, and a specific example of an environmental impact could be carbon emissions footprint. For the example of a carbon emissions footprint, different supply chain configurations and choices can have environmental and cost implications. Specifically, the Orchestrated Intelligent Supply Chain Ecosystem 100 can compute the explicit costs of land and air transportation, the implied costs of these choices induced by differences in delivery time, inventory holding requirements and delivery time variability and also the different carbon emissions costs induced by these choices. Carrying the example further, depending upon whether the customer is subject to carbon taxes, requirements for carbon offsets or even voluntary carbon offsets, the costs of these factors can be included in the computation of costs implied by each supply chain configuration decision.

The Global Factors Policy Module 435 considers at least three areas of factor for the inclusion of Global Factors in supply chain optimization: Explicit sources of Global Factors costs, the ultimate disposition and publication of Global Factors results and the strategic objectives and preferences of the customer in the computation of Global Factors. The first of these, explicit sources of Global Factors costs, includes information on what kinds of Global Factors costs the organization is subject to (for example, carbon taxes, environmental offsets and/or credits, compliance offsets, voluntary offsets, etc.) and what the specific costs for these factors are. These inputs are imported by Global Factors Parameter Interface 255, including in some cases real time information pertaining to live market costs of carbon offsets or other commodities. The ultimate disposition and publication of Global factors pertains to internal and external reporting and display of Global Factors results. Outputs in this category include, but are not limited to, internal dashboards and reports of costs, tradeoffs and impacts of supply chain optimization activities, external reporting for regulatory compliance or for public communication and interaction with live interfaces, including transactional markets for environmental offsets (where bids might be published for the required offset commodities and actual purchase and sale transactions of these commodities might be carried out). Strategic objectives and preferences for the organization pertaining to Global Factors could include many factors that impact how the costs are computed and how tradeoffs are valued, such as which types and sources of offset commodities might be acceptable or preferred for purchase, how much “effective cost” for Global Factors should be taken into account (for example is an offset cost of $1000 equivalent to a “hard cost” of $1000 to transport materials from one location to another), and what publication, reporting, dashboard and tracking activities should take place within the organization. Taken together, these three categories of input parameters determine the cost and tradeoff structure that drives optimizations of a supply chain in a way that includes Global Factors.

The Supply Chain Attributes Definition Module 440 objective is to characterize the physical and performance characteristics of the relevant parts of a supply chain quantitatively. The definition of “relevant parts” of a supply chain in this context is any physical or logical aspect of a supply chain that materially influences the selection or computation of optimal supply chain operating parameters. For example, while a customer’s supply chain globally may include supply chain networks in North America and Europe, it may be the case that these supply chains are entirely decoupled and do not influence each other's behavior. In this case then, the “relevant parts” of the supply chain in the optimization of product delivery to Spain would include the European supply chain but not the North American supply chain. This is not to imply that relevancy is only determined by geographical factors. As another example, it may be that the performance of a leaf node of a supply chain can be completely characterized by the delivery performance of a single node upstream along with total transportation costs to the leaf node and manufacturing costs for the product. In this case, it may be quantitatively acceptable to ignore supply chain network nodes between the manufacturer and the first node upstream from the leaf node, effectively rendering those intermediate nodes as not “relevant parts” of the network for the purpose of optimizing the leaf node operating parameters. This is an important point, because it is a unique characteristic of the present invention that complete knowledge of all supply chain attributes in a customer’s entire supply chain is not required to arrive at quantitatively and qualitatively optimal parameters.

In some embodiments, the Supply Chain Attributes Definition Module 440 can operate in several modes. In the first mode (“fixed network mode”), the physical attributes of the supply chain network upstream of leaf nodes are assumed to be fixed. This means that the locations and roles of different nodes in the supply chain are not considered to be free parameters of the optimization process. The actual outputs and behavior of each node may be highly variable, but the presence, role and operational characteristics of each node may not be changed by a user in this mode. To be specific, in this mode, the optimization process carried out by Orchestrated Intelligent Optimization Module 230 optimizes leaf node supply chain operational parameters such as reorder strategy, reorder frequency, safety stock level and others, subject to system-level constraints such as total orders serviced by each supply site per year. This is an optimization of certain parameters, holding the overall structure of the network fixed (although again, the actual outputs of this fixed system can be highly variable and may be modeled algorithmically by the system).

In another mode, the “fixed network end-to-end optimization mode”, the locations and roles of supply chain network nodes upstream from leaf nodes are considered to be fixed, but some of their operational parameters may be optimized subject to system-level constraints. In this mode, the amount of inventory to be held, the reorder frequency and strategy of the node and the allocation rules for supplying downstream nodes are examples of parameters that might be optimized by the Orchestrated Intelligent Supply Chain Ecosystem 100.

In yet another mode, the actual locations and roles of nodes across the entire supply chain may be optimized by the Orchestrated Intelligent Supply Chain Optimizer 150 (“full end-to-end network optimization mode”). In this mode, the actual opening, closing and modification of physical facilities may be contemplated as part of the optimization. For example, it may be more efficient to open a new upstream supply warehouse to service multiple complex products than to place increased demands on an existing warehouse that has reached operational capacity.

In some embodiments, users may suggest or test certain optimizations, in other options for optimization may be suggested entirely by algorithmic means (for example using machine learning or AI), and in others a combination of both user input and algorithmic suggestions may be employed, resulting in a system that can flexibly identify optimal supply chain configurations for different customer situations.

The consequential output of Supply Chain Attributes Definition Module 440 is a sufficient characterization of the quantitative aspects of the supply chain to allow the Orchestrated Intelligent Supply Chain Optimizer 150 to carry out the computations defined in Future Performance Predictor 450.

Future Performance Predictor 450 is a cornerstone of the Orchestrated Intelligent Optimization Module 230 in which future performance of the supply chain for each fixed set of operational parameters is predicted for the supply chain defined in Supply Chain Attributes Definition Module 440. In this module, each fixed set of operational parameters can be viewed as in input feature vector to the prediction module, and the predicted performances for all input feature vectors are then both archived and passed to Optimized Parameters and Sensitivities Computation Module 460 in order to perform constrained optimization on the entire system and to arrive at recommended operational parameters.

A variety of methods can be used to determine the complete set of input feature vectors to be used in Future Performance Predictor 450. For example, a fixed grid of parameter values (for example, reorder frequency, safety stock and upstream delivery performance variability) might be created and future predictions for all of these input feature vectors computed.

In some embodiments, an adaptive approach to input feature vector selection might be used to improve computational performance. For example, input feature vectors could be selected to follow along contours of fixed Service Level, or a gradient-based search algorithm could be employed to rapidly identify input feature vectors near local optima. Many different algorithmic approaches might be employed in this phase to build up a representation of the system behavior.

Given an input feature vector for the supply chain, the predicted future behavior may be determined by a variety of algorithmic methods. For example, one might train an AI system to predict future performance based on the input feature vector and supply chain network attributes. Alternatively, one might use a statistical approach to compute probabilities of different outcomes, such as a stockout or a reorder. Additionally, one might use a simulation approach to generate an ensemble of different future behaviors and then compute estimates and confidence levels of future outcomes based upon these ensembles. It is envisioned that a variety of algorithmic techniques may applied in this phase to predict the implications of different parameter selections. For example, a formal sensitivity analysis can be performed so that an estimate of the future outcome can be broken down into its constituent uncertainties and ranked so that the customer can be warned of the items that are the most pressing.

A critical component of the Future Performance Predictor 450 process is to forecast future product demand. In some embodiments, modeling and forecasting of product demand is performed entirely within this module and using algorithmic methods developed and/or implemented within the Orchestrated Intelligent Supply Chain Optimizer 150. In other embodiments, forecast sales values and or algorithmic formulations of product sales forecasts may be incorporated and used alongside internal forecast methodologies. Such an approach allows external business knowledge of future sales events (for example, promotional events, government drug purchase tenders, new product introductions, or expiration of a drug patent) to be incorporated into the prediction process, but not at the expense of advanced analytical prediction methods that have been developed internal to Orchestrated Intelligent Supply Chain Ecosystem 100.

The function of Optimized Parameters and Sensitivities Computation Module 460 is to identify optimal supply chain parameters based on the system performance predictions computed in Future Performance Predictor 450. The AI modelling algorithm seeks to identify based on the input parameters both imported and computational the optimal configuration response to meet targeted parameter constraints with the current and predicted levels of variability as identified in the input data. The models seek the optimal balance between service and target for that part of the supply chain selected for the computation. An additional function of Optimized Parameters and Sensitivities Computation Module 460 is to compute the relative sensitivities of recommended parameters to underlying variables. Each of these will be described below.

To identify optimal supply chain parameters, this module searches the space of all possible input feature vectors (the operational parameters of the supply chain that are desired to be optimized, such as reorder frequency and safety stock level for each product) and identifies an optimal set of such parameters, subject to the system-level constraints defined in Strategic Parameters and Constraints Definition Module 430.

In some embodiments, this process may be carried out in an iterative fashion in conjunction with Future Performance Predictor 450. There is a tradeoff between the granularity and completeness of the coverage of input feature vectors in Future Performance Predictor 450, which can generate a large amount of data and consume significant compute time, and the speed of the optimization and analysis process. The Orchestrated Intelligent Optimization Module 230 is designed to exploit these tradeoffs to provide maximal flexibility, accuracy and performance (including user experience) during the identification of optimal supply chain operational parameters.

In some embodiments, Future Performance Predictor 450 will include cost and impact computations that incorporate Global Factors such as environmental impact, cost of regulatory and voluntary offsets of such impacts, and other computed factors that might influence supply chain optimization. Some of these computations incorporate external costs of offset commodities and/or tax rates, which may be modeled within this module, or received as inputs to this module through inputs to the system from Global Factors Parameter Interface 255. In some embodiments, these inputs may be retrieved from live marketplaces in which offset and other Global Factor commodities are priced and traded in real time, and actual purchase/sale transactions of such commodities may be triggered (and/or executed) as part of the optimization computation (for example in order to ensure that the actual cost of the supply chain is consistent with the optimization computation).

The process to compute sensitivities of recommended supply chain operational parameters to underlying factors is carried out by comparing the predicted performance of the supply chain for input feature vectors near the recommended optimal parameters. By creating an internal model of the behavior of the system in the neighborhood of each recommended optimal parameters, the Optimized Parameters and Sensitivities Computation Module 460 can identify which factors are most likely to significantly alter the results of the analysis if they were to change, or if they were to be more accurately characterized in the data coming into the system at Data Management Module 220. Such results are presented to users at Data Management Module 220 and/or User Feedback Module 240, depending upon the permissions and characteristics of each user. In some embodiments, results from this analysis might be communicated to customer outside of the Orchestrated Intelligent Supply Chain Optimizer 150.

For example, the average inventory required to maintain a high Service Level for a product might be very sensitive to the Service Level, making it prudent to investigate whether such a high Service Level is indeed appropriate for the product. In another example, the sensitivity analysis may identify a modeled delivery performance that has a very large impact on underlying product availability performance. In such a case, the availability of this information to users allows the customer to make an informed decision about the value of investing resources to either more carefully characterize the delivery performance, or to actually take steps to improve the reliability of that delivery system. In either case, access to such sensitivity information is highly valuable to the customer in determining how to allocate assets and effort in the service of improving the overall performance of the stakeholder’s respective supply chain.

A Results Prioritization Module (not illustrated) performs an analysis of all of the recommended parameter settings based on the optimization in Optimized Parameters and Sensitivities Computation Module 460 and then computes importance factors that determine how the results are displayed to the user. In some cases, all of the results might be presented in a single table, sorted in an order selected by the user. However, in many cases, because the number of products can be very large, it is critical to use analytical techniques to prioritize results and optimize the presentation of these results.

This is especially important given the fact that users have the option to use recommended optimal supply chain parameter values, or to override them. This means that after each analysis, there can be parameters that are far from their optimal values, and which subsequently can represent significant risk for the customer.

Hence, Results Prioritization Module applies analytical techniques (machine learning and AI in some embodiments) to determine which recommendations are most important to act on, for example because they mitigate risk or have large revenue implications. While this invention is applicable to supply chains in any industry or product area, as an example, consider an HIV product for which there are significant health implications if a stockout occurs. Because of changes in demand variability, or because of previously suboptimal manually set supply chain parameters, such a product might represent a significant risk to patients and the customer. Such a product would be assigned high priority in this module so that appropriate action could be taken by a user.

In some embodiments, Results Prioritization Module may trigger purchase and/or sale transactions of commodities (for example carbon offsets) that are required to perform the optimizations imagined in Future Performance Predictor 450. Once specific optimization choices are selected, the customer may elect to “lock in” the pricing of offsets or other commodities in order to ensure that the computations are reflective of actual conditions (in other words, to avoid changes in the price that might change the optimal solution or induce increased operational costs).

These prioritized results are transmitted to either Data Management Module 220 or User Feedback Module 240, depending upon what inputs they pertain to, and which kind of user is most appropriate to act upon them. For example, an adjustment to Service Level or safety stock level might be made by a Planner, but a project to investigate delivery performance at a supply chain node might be initiated by a supply chain manager or IT director.

Additionally, the Visualization Module 470 may take the output of the Results Prioritization Module and generate specific graphical representations of the output for user consumption.

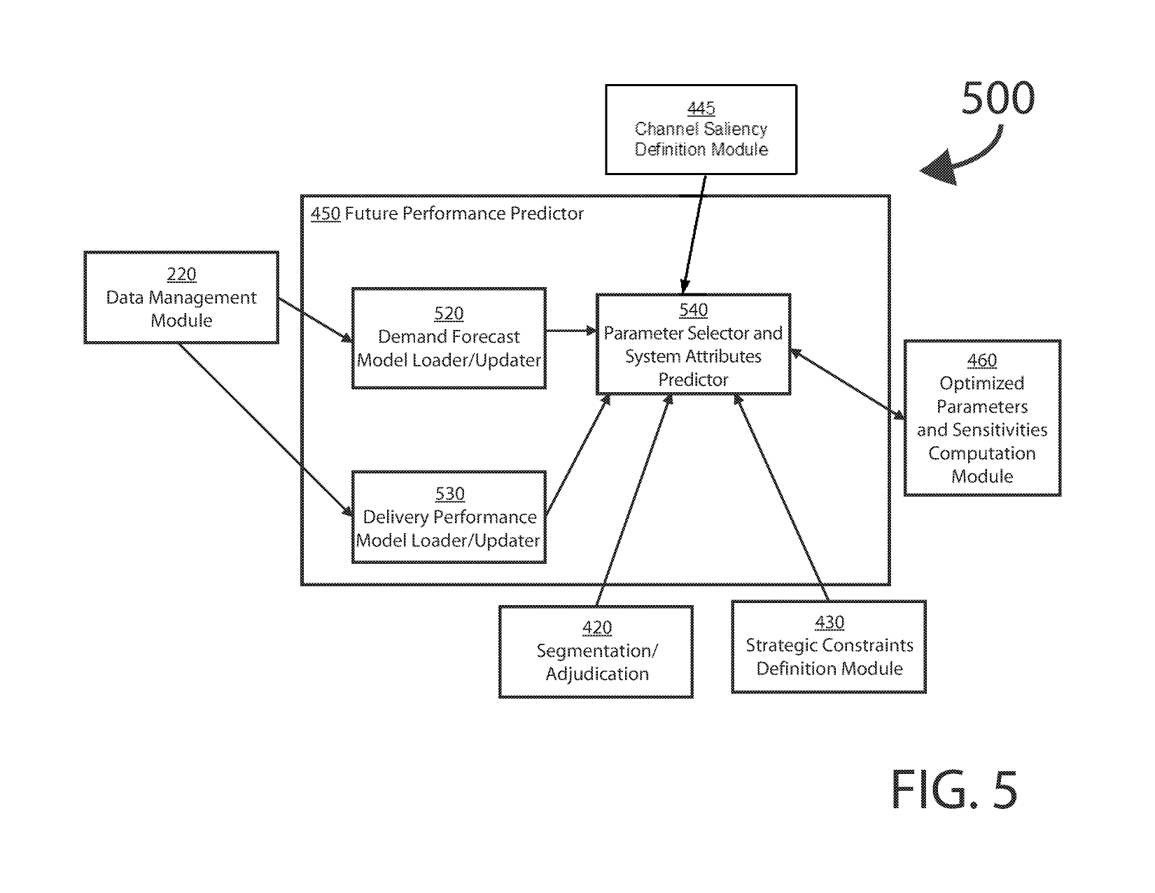

Referring now to FIG. 5, a critical component of the Future Performance Predictor 450 process is to forecast future product demand. In some embodiments, modeling and forecasting of product demand is performed entirely within this module and using algorithmic methods developed and/or implemented within the Orchestrated Intelligent Supply Chain Optimizer 150. In other embodiments, forecast sales values and or algorithmic formulations of product sales forecasts may be incorporated and used alongside internal forecast methodologies. Such an approach allows external business knowledge of future sales events (for example, promotional events, government drug purchase tenders, new product introductions, or expiration of a drug patent) to be incorporated into the prediction process, but not at the expense of advance analytical prediction methods that have been developed internal to the Orchestrated Intelligent Supply Chain Ecosystem 100.

In Demand Forecast Model Loader/Updater 520 internal modeling and forecasting assets are applied to product sales demand data from Data Management Module 220 to generate one or more product sales forecasts. In some embodiments, a customer generate forecast or forecasting model may be loaded in order to supplement the scope of future performance predictions.

In a parallel process of some embodiments, forecast and demand history time series data are updated in an ongoing monitoring process and a model representing the relationship between forecast and demand is updated. This model takes into account the likely variation between sales forecast and actual realized demand. For example, if the sales forecast is consistently higher than the actual demand, then the model will learn this. By a similar token, the model will learn the variability of actual demand relative to the single sales forecast.

This model of the relationship between sales forecast and demand history can be used to generate bias and noise terms for use in the regression calculation that generates the posterior distribution from the forecast and the prior.

Functions drawn from the posterior distribution can then be used as probability-weighted future demand scenarios in the construction of a SMSpace which can then be used in the global optimization of an end-to-end supply chain.

An important component of the Future Performance Predictor 450 process is to forecast future product delivery performance throughout the supply chain network. In some embodiments, modeling and forecasting of product delivery performance is performed entirely within this module and using algorithmic methods developed and/or implemented within the Orchestrated Intelligent Supply Chain Optimizer 150 as applied to historical delivery performance data. In other embodiments, historical delivery performance data may not be available, so supplementary information such as delivery performance models developed by the customer may be used.

In Delivery Performance Model Loader/Updater 530 internal modeling and forecasting assets are applied to historical delivery performance data from Data Management Module 220 to generate one or more estimates of future delivery performance. In some embodiments, a customer generated model or performance estimate may be loaded in order to supplement the scope of future performance predictions.

As described above, Future Performance Predictor 450 is a cornerstone of the Orchestrated Intelligent Optimization Module 230 in which future performance of the supply chain for each fixed set of operational parameters is predicted for the supply chain defined in Supply Chain Attributes Definition Module 440. In this module, each fixed set of operational parameters can be viewed as in input feature vector to the prediction module, and the predicted performances for all input feature vectors are then both archived and passed to Optimized Parameters and Sensitivities Computation Module 460 in order to perform constrained optimization on the entire system and to arrive at recommended operational parameters.

A variety of methods can be used in Parameter Selector and System Attributes Predictor 540 to determine the complete set of input feature vectors to be used in Future Performance Predictor 450. For example, a fixed grid of parameter values (for example, reorder frequency, safety stock and upstream delivery performance variability) might be created and future predictions for all of these input feature vectors computed.

In some embodiments, an adaptive approach to input feature vector selection might be used to improve computational performance. For example, input feature vectors could be selected to follow along contours of fixed Service Level, or a gradient-based search algorithm could be employed to rapidly identify input feature vectors near local optima. Many different algorithmic approaches might be employed in this phase to build up a representation of the system behavior.

Given an input feature vector for the supply chain attributes, parameters and/or configuration, the predicted future behavior may be determined by a variety of algorithmic methods. For example, one might train an AI system to predict future performance based on the input feature vector and supply chain network attributes. Alternatively, one might use a statistical approach to compute probabilities of different outcomes, such as a stockout or a reorder. Additionally, one might use a simulation approach to generate an ensemble of different future behaviors and then compute estimates and confidence levels of future outcomes based upon these ensembles. It is envisioned that a variety of algorithmic techniques in this phase to predict the implications of different parameter selections.

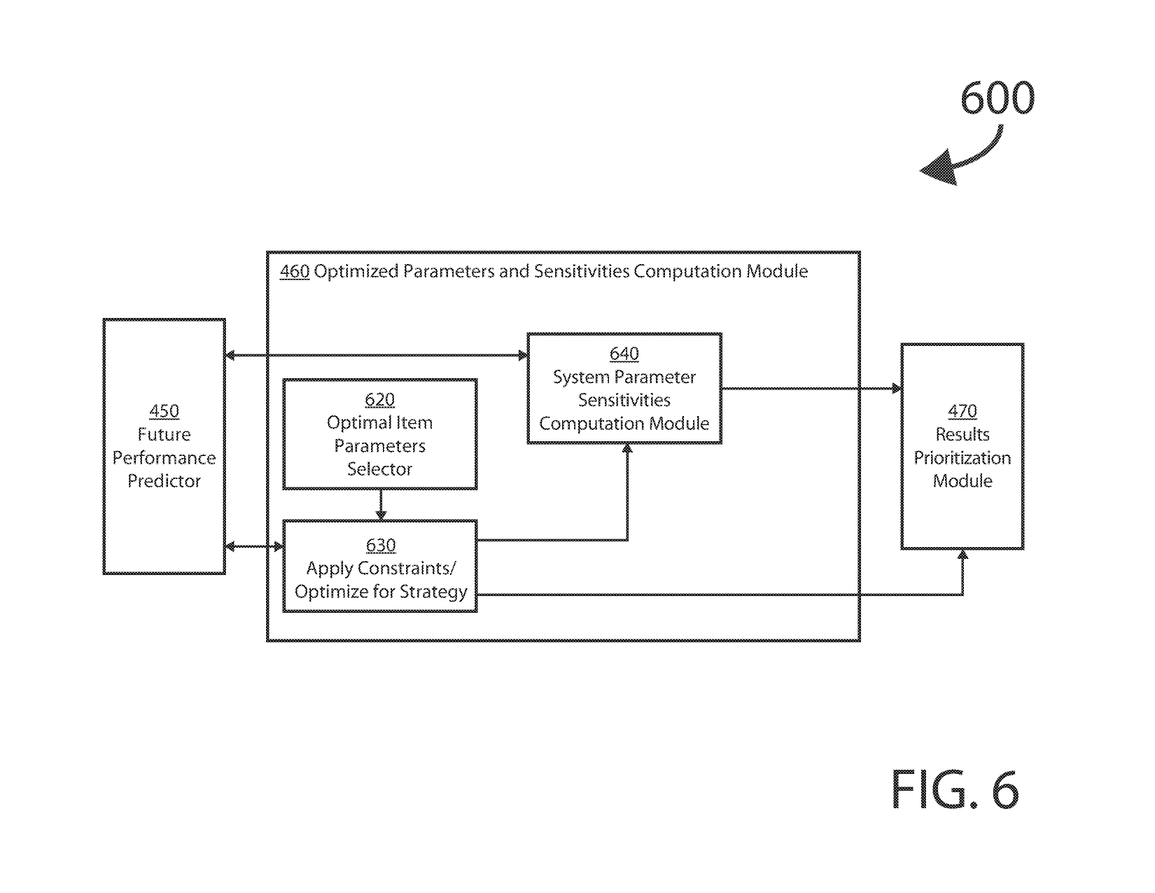

As shown in FIG. 6, the function of Optimized Parameters and Sensitivities Computation Module 460 is to identify optimal supply chain parameters based on the system performance predictions computed in Future Performance Predictor 450. An additional function of Optimized Parameters and Sensitivities Computation Module 460 is to compute the relative sensitivities of recommended parameters to underlying variables. Each of these will be described below.

To identify optimal supply chain parameters, the Optimal Item Parameters Selector 620 searches the space of all possible input feature vectors (the operational parameters of the supply chain that are desired to be optimized, such as reorder frequency and safety stock level for each product) and identifies an optimal set of such parameters, subject to the system-level constraints defined in Strategic Parameters and Constraints Definition Module 430. In some embodiments, Optimal Item Parameters Selector 620 works with Apply Constraints/Optimize for Strategy Module 630 in an iterative fashion to navigate the space of input feature vectors in order to determine the optimal set of parameters that satisfies system level constraints.

In some embodiments, this process may be carried out in an iterative fashion in conjunction with Future Performance Predictor 450. There is a tradeoff between the granularity and completeness of the coverage of input feature vectors in Future Performance Predictor 450, which can generate a large amount of data and consume significant compute time, and the speed of the optimization and analysis process. The Orchestrated Intelligent Optimization Module 230 is designed to exploit these tradeoffs to provide maximal flexibility, accuracy and performance (including user experience) during the identification of optimal supply chain operational parameters.

To identify optimal supply chain parameters, the Optimal Item Parameters Selector 620 module searches the space of all possible input feature vectors (the operational parameters of the supply chain that are desired to be optimized, such as reorder frequency and safety stock level for each product) and identifies an optimal set of such parameters, subject to the system-level constraints defined in Strategic Parameters and Constraints Definition Module 430. In some embodiments, Optimal Item Parameters Selector 620 works with Apply Constraints/Optimize for Strategy Module 630 in an iterative fashion to navigate the space of input feature vectors in order to determine the optimal set of parameters that satisfies system level constraints.

The process to compute sensitivities of recommended supply chain operational parameters to underlying factors is carried out in System Parameter Sensitivities Computation Module 640 by comparing the predicted performance of the supply chain for input feature vectors near the recommended optimal parameters. By creating an internal model of the behavior of the system in the neighborhood of each recommended optimal parameters, the Optimized Parameters and Sensitivities Computation Module 460 can identify which factors are most likely to significantly alter the results of the analysis if they were to change, or if they were to be more accurately characterized in the data coming into the system at Data Management Module 220. Such results are presented to users at Data Management Module 220 and/or User Feedback Module 240, depending upon the permissions and characteristics of each user. In some embodiments, results from this analysis might be communicated to customer outside of the Orchestrated Intelligent Supply Chain Optimizer 150.

For example, the average inventory required to maintain a high Service Level for a product might be very sensitive to the Service Level, making it prudent to investigate whether such a high Service Level is indeed appropriate for the product. In another example, the sensitivity analysis may identify a modeled delivery performance that has a very large impact on underlying product availability performance. In such a case, the availability of this information to users allows the customer to make an informed decision about the value of investing resources to either more carefully characterize the delivery performance, or to actually take steps to improve the reliability of that delivery system. In either case, access to such sensitivity information is highly valuable to the customer in determining how to allocate assets and effort in the service of improving the overall performance of the supply chain.

When limitations on supply chain resources are in effect (for example, when insufficient raw materials are available to make enough product to satisfy predicted demand) then optimization in Optimized Parameters and Sensitivities Computation Module 460 most incorporate Channel Saliency values to determine how to allocate products to specific channels. The results of this optimization can be parameterized as traditional supply chain planning parameters (for example safely stock and reorder amount) or they can be operated as real time product routing system in which the system directly computes and recommends movements of materials through the supply chain in order to satisfy constantly changing constraints in availability of resources, products and materials with simultaneously changing transportation performance and channel demand levels. Supple chain environments that experience frequent disruption often require such a constrained, real-time channel-sensitive optimization approach.

An example is in the case of pandemic disruption. where limited supply of vaccines needs to be administered, public health policy makers have to prioritize specific. cohorts of patients based on ages and comorbidities and can define channels. appropriately and can provide a relative prioritization. For example, A public health policy maker might define cohorts such as Ages 50-60 and Gender is Male" or Ages" 70+ and has 2 or more comorbidities. " The system constructs channels based on the above definition and the public health policy maker can assign priorities to each of the above-mentioned channels. In addition to the channel data, demographic data within specified geographic regions is also taken into account in the simulation where it generates plans based on the distribution of the cohorts with geographic regions and the priorities defined by public health policy makers.

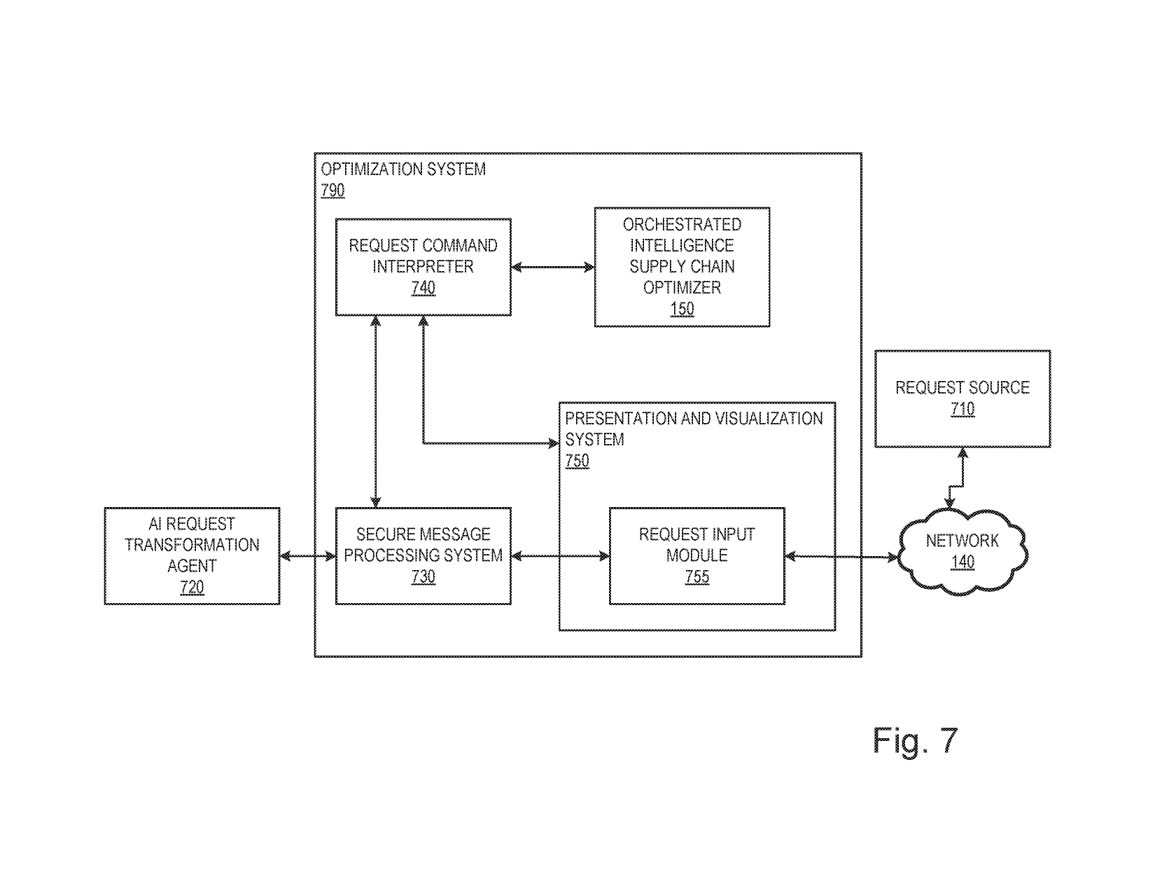

Turning now to FIG. 7, the system for natural language queries, in a secure manner, for the testing or configuration of a supply chain optimization is provided. In this system, a request source 710, who is typically a planner or other user, provides a query in a natural language format via an interface displayed on their local system. The request source 710 accesses the optimization system 790 via the network 140 as previously discussed. The natural language query is received by a request input module 755, which is an unstructured input/output mechanism (e.g., text, voice, video, data representation or feature space vector from another system) which allows the request source 710 to request information from the optimization system 790. Messages are passed to the secure message processing system 730 for further processing. The secure message processing system 730 receives the input from the request input module 755 and adds context to the message (augments the message) to improve the precision of utility of the expected output from the AI request transformation agent 720. An example of this type of augmentation may include providing instructions regarding who is making the request and what their objectives are. Examples od such augmented instructions could include the following: “The user is a VP of Supply Chain who is interested in high-level summary information about an entire program to support decision making” or “The user is a Planner who is interested in the tradeoffs involved in different SKU-level parameter decisions”.

The secure message processing system 730 may additionally scan the input message for sensitive information in the query that cannot/should not be passed to a non-secure AI request transformation agent 720. The AI request transformation agent 720 is generally owned and operated by a third party (e.g., Microsoft for ChatGPT variants) which consumes information fed to it an incorporates the information into its knowledge base. When specific information is sensitive or confidential, it may be necessary to prohibit such information from being supplied to such an AI request transformation agent 720.

Detection of sensitive data can be carried out in a number of ways, including but not limited to, applying whitelists or blacklists that have been explicitly created for data in the optimization system 790, or by identifying the semantic classes of information in the message and inferring that certain information is sensitive (e.g., profit margin for a pharmaceutical product > 500% could be considered sensitive business information). When sensitive data is detected, in some embodiments, the data will be transformed to synthetic data of a similar semantic type (e.g. “secretBrand1” might be transformed to “productFamily1” or “itemName1”, depending on the semantic type of “secretBrand1”. Messages returned by the AI request transformation agent 720 are then transformed back to their original “sensitive” form for further presentation and processing in the optimization system 790.

The request command interpreter 740 receives messages from the AI request transformation agent 720 via the secure message processing system 730. These messages have the original data values restored (when sensitive data was present and extracted/replace prior to communication with the AI request transformation agent 720). This data restoration is possible as the optimization system 790 is trusted for sensitive customer information.

The request command interpreter 740 translates the output to specific function and API calls. For example, the AI request transformation agent 720 might return a message to “call WorldView function with arguments (service risk, current, {breads, biscuits}, Europe)” which would be translated to the exact function call used by the optimization system 790 to present the World View for the requested parameters. Depending on the user interface and workflow context, the request command interpreter 740 may add additional information to the function call to ensure workflow continuity and consistency of information (for example, if the current scope of the analysis was already ‘breads and biscuits in Europe’, then even if these values are not passed by the secure message processing system 730, they would be added to the function calls used to present information to the user.

The presentation and visualization system 750 is a module within the optimization system 790 which controls the user experience. This module enables unstructured inputs to the system from the request input module 755 and manages any interactions with other user experience interface controls and the like.

The orchestrated intelligence supply chain optimizer 150 has been described in great detail previously. This system includes all computational components required to compute relevant information for users. Interaction with the orchestrated intelligence supply chain optimizer 150 can be through function calls or API calls, depending on the context. In some embodiments, a complex request from a user might be calculated by applying a series of linked computational requests. Some linked computations may be prepackaged as functions or API calls and others may be assembled ad hoc by the AI request transformation agent 720.

The AI request transformation agent 720 is any agent that can take a request and translate it into a specific series of functional and/or visualization actions in the optimization system 790. This AI request transformation agent 720 is not assumed to be secure so that it is generally not permissible to pass sensitive information into it. The role of the secure message processing system 730 is to act as a security firewall to ensure that requests do not transmit sensitive data into the AI request transformation agent 720. In some embodiments, the AI request transformation agent 720might be a services connection to a foundational AI system such as GPT, Gemini or Llama, or it may be an AI processing program such as a RAG system optimized by DSPy, LangChain, or other AI development environment. Any methodology to transform a request into a series of concrete, potentially interdependent actions by the optimization system 790 could be used as the AI request transformation agent 720.

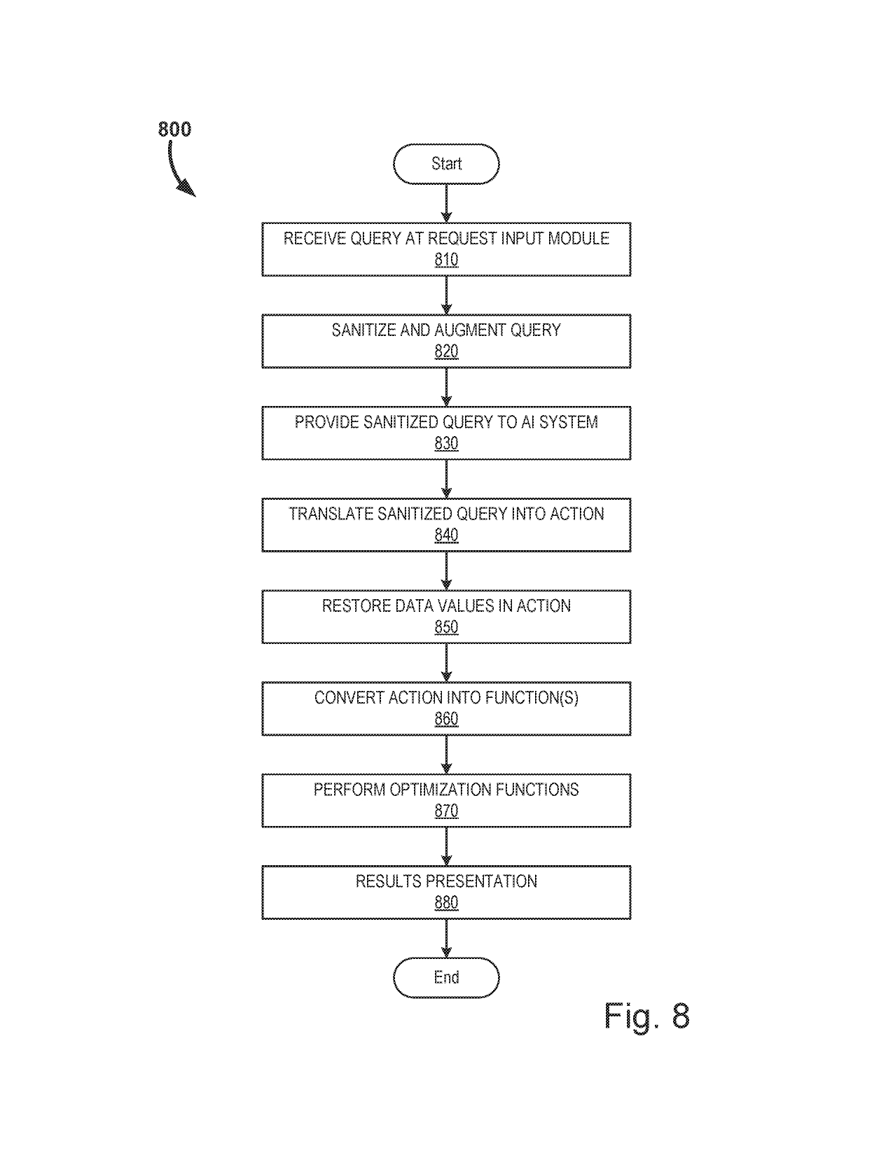

Turning now to FIG. 8, the process of consuming and analyzing a natural language query of a supply chain optimization is provided, shown generally at 800. In this example process, initially a query is received (at 810) at the request input module. The query/request can be an unstructured text, audio, video, data structure or vector value, in some embodiments. The query may be received via the network from a user, typically a planner or other interested party.

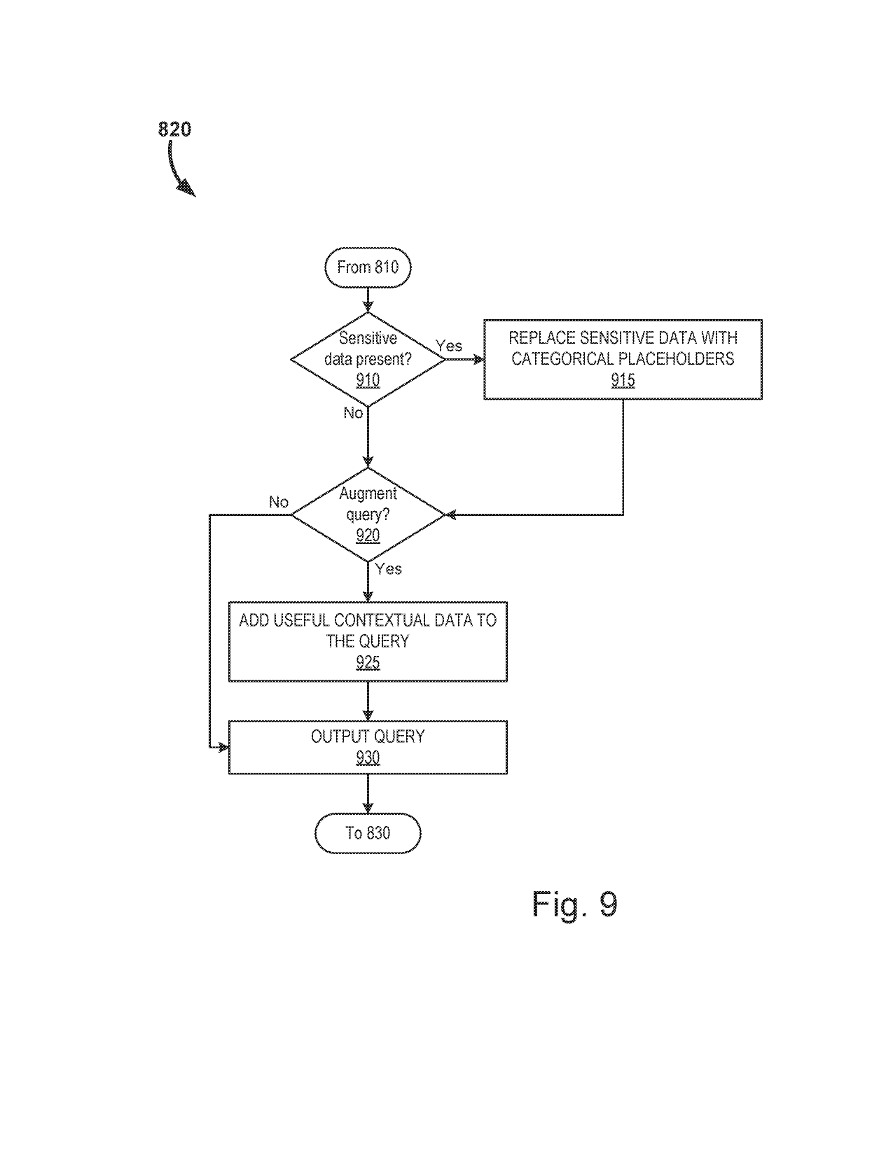

The query is then sanitized and augmented (at 820). Sanitization and augmentation is provided in greater detail in relation to FIG. 9. In this sub-process, initially a determination is made whether sensitive data is present (at 910). This determination may rely upon white or black listing, or by identifying the semantic classes of information in the message and inferring that certain information is sensitive. For example, information related to the business that is codenamed, belongs to particular product segments with particular attributes, or otherwise is identifiable as confidential may all be flagged as “sensitive” by the system and appropriately handled.

When sensitive data is present, the system may replace the sensitive data with a categorical placeholder or other synthetic data (at 915). For example, if the business is entering the bread market, but this data is not yet public, the system could genericize the query to remove any reference to bread and rather replace it with a placeholder (e.g., ProductSegment1) or with a synthetic placeholder (e.g., BakedGoods). In addition to determining and handling sensitive data, the system may augment the query when additional useful data is present. A determination is made whether such an augmentation is desired (at 920). Generally, if information is available that will provide context to the query, an augmentation will be desired as it enhances the systems output. The useful contextual data is then added to the query (at 925). Planner information, motivation, and the like may be augmented to the general query. After augmentation (or in the event there is no data to augment the query), the system may output the altered query (at 930).

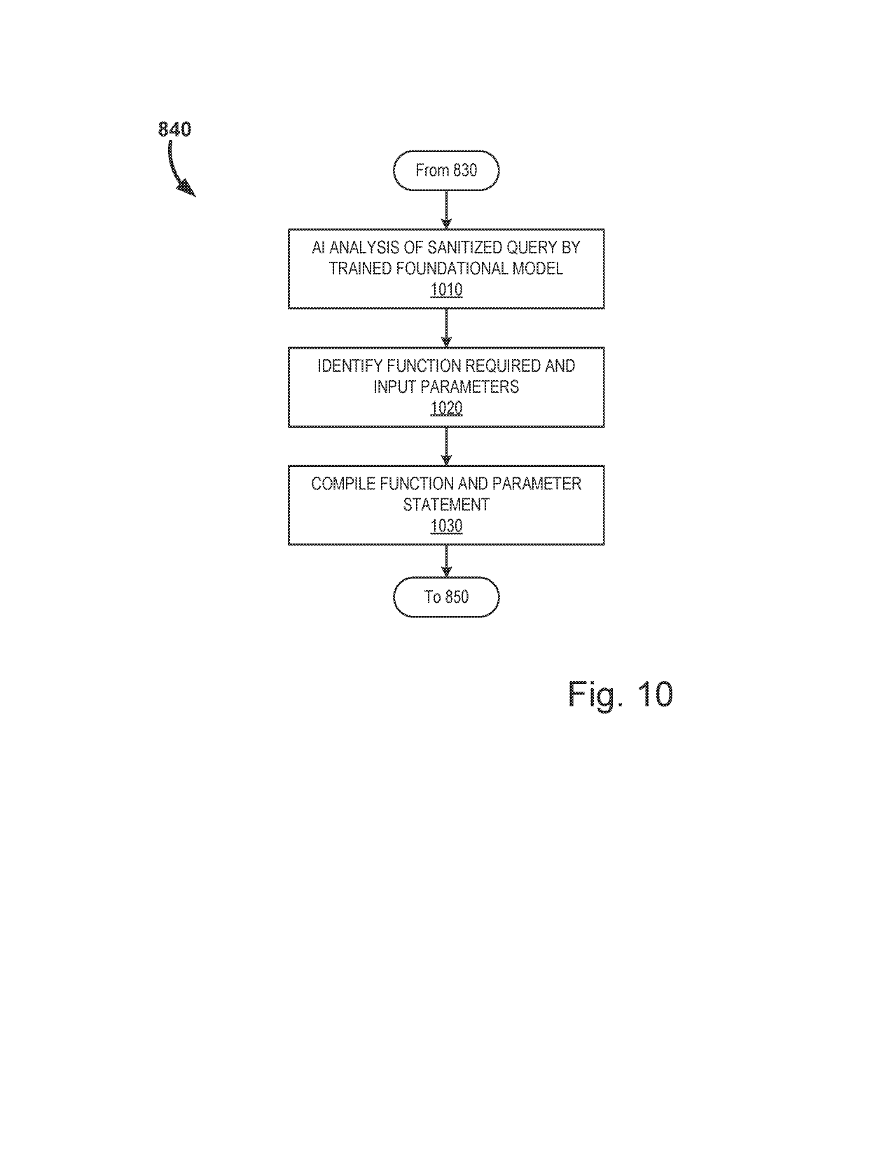

Returning to FIG. 8, the alter query is provided to the AI request transformation agent 720 (at 830). The AI system is generally a foundational model system that has been locally trained to convert natural language queries into actions for the optimization system 790. This translation of the sanitized/altered query (at 840) is provided in greater detail in relation to FIG. 10. Initially, the sanitized query is analyzed by the trained foundational model (at 1010). The AI model is capable of identifying the functions required and the input parameters for the query (at 1020). The output is then compiled as a function and parameter statement (at 1030).

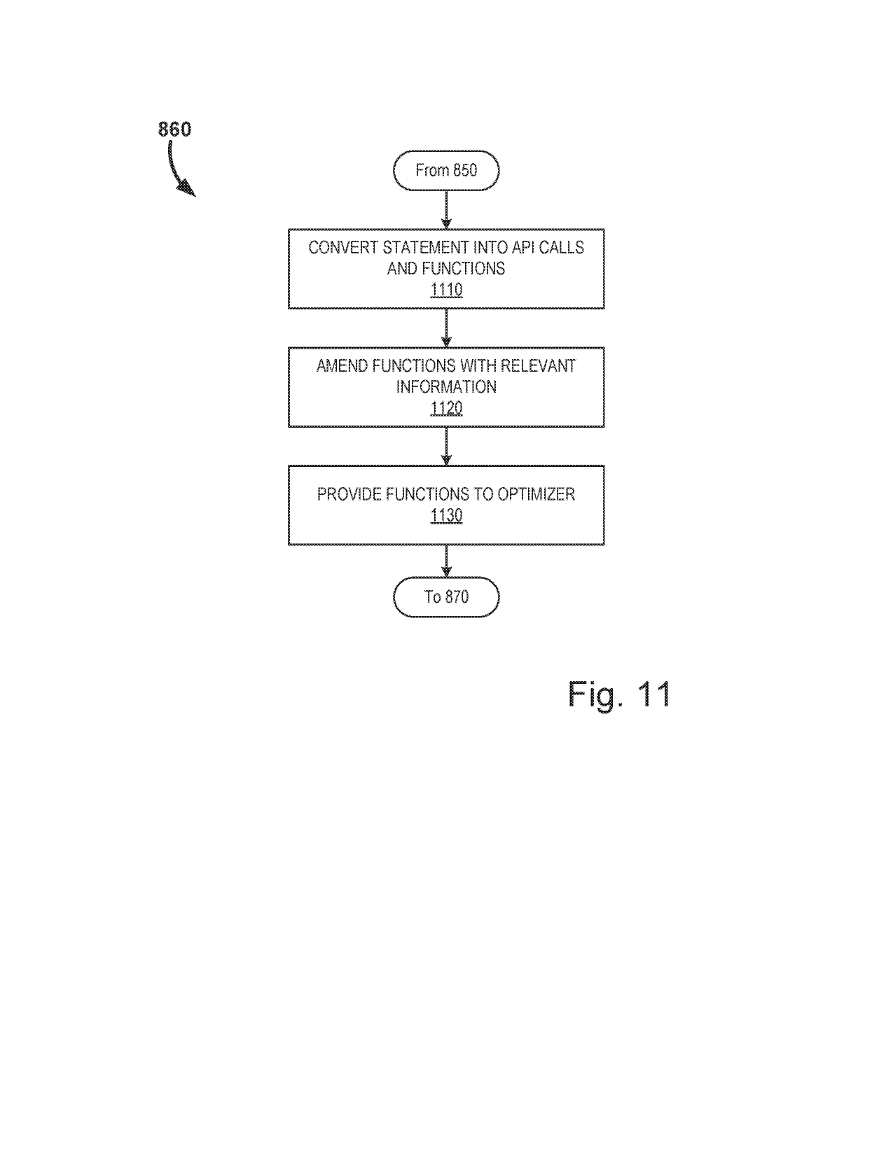

Returning to FIG. 8, the function and parameter statement/action is received again by the optimization system 790 which is a secure environment. This allows the placeholders for the sanitized data fields to be restored with the appropriate data (at 850). The action, with restored values, may then be converted into one or more functions (at 860) depending upon the query complexity. FIG. 11 provides greater detail of the function generation process. Initially the function and parameter statement is converted into API calls and functions (at 1110). The functions are then amended with additional relevant information (at 1120). The functions are then provided to the optimizer 150 (at 1130) for the actual analysis.

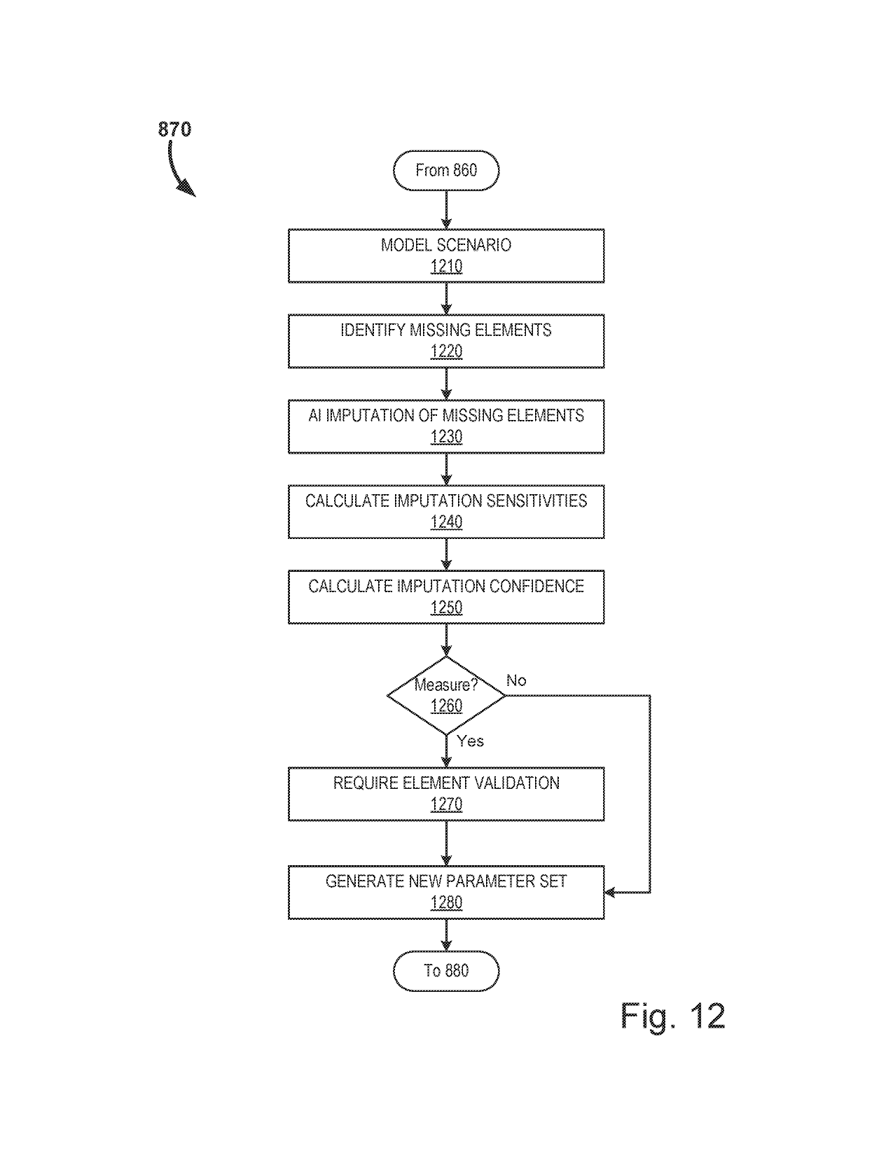

Returning to FIG. 8, the optimization functions are then performed (at 870) as seen in greater detail in FIG. 12. The scenario itself needs to be initially modeled (at 1210). For example, if a geography cannot be utilized, new shipping routes and warehousing locations must be identified. Costs and time/performance for these new shipping routes and warehousing locations are needed. In some cases, this information is already known from past data sources. In other cases, the system may identify missing data elements (at 1220). The imputation engine may utilize AI algorithms to impute these missing values (at 1230). Imputation utilizes other data points which are related to the missing data points to generate a prediction for the missing data points. For example, the cost of a warehouse may be imputed based upon the cost of other warehouse facilities in geographically similar locations (e.g., same region, same population densities, same number of surrounding warehousing facilities, etc.).

The sensitivities of the optimization for the given missing element(s) are determined (at 1240) based upon the optimization model. Elements that impact the model output significantly have a higher sensitivity, whereas model elements that have relatively small impact upon the performance may have a lower sensitivity. Likewise, the imputation engine is capable of determining the confidence in the prediction (at 1250). Confidence is based upon the AI algorithm’s ability to accurately generate the prediction, and is directly related to the quality, quantity and relevancy of the data used to perform the prediction. For example, determining warehouse costs for a given warehouse, where the costs are known for a half dozen warehouses within a hundred-mile radius, and where the costs are consistent between the various warehouses, will generate an imputation for the warehouse cost with a very high degree of confidence. In contrast, if the warehouse is remote, and the closest three warehouses that have somewhat similar characteristics vary significantly in price, the system will generate a prediction with an extremely low confidence level. In some embodiments, the imputation model generates a prediction and a confidence interval.

Even when the confidence is low for a missing data element it does not necessarily mean that the modeled scenario is inaccurate or useless. What matters is the interplay of the imputation value’s confidence and the sensitivity of the scenario model to the imputed value. When the model is very sensitive to the missing value, the need for the imputed value to be very accurate/high confidence is significantly higher. In contrast, low sensitivity to the missing value may tolerate a lower confidence level. In some embodiments, a ratio of the confidence level and the sensitivity may be generated. Only values over a configured threshold may be deemed “acceptable” for modeling. This ratio comparison may determine if there is a need to measure a given missing element, or if the scenario model is deemed acceptable (at 1260). When all missing elements are acceptable, a new set of parameters based upon the scenario model may be generated (at 1280). However, if some of the missing values are below a threshold/not acceptable, the system may send the user a validation requirement (at 1270). This validation may require the user to collect the missing information (e.g., contacting the warehouse for pricing data), or manually inputting the missing elements. Once validation of the missing data is performed, the system may complete the generation of the variable set.

After variables have all been defined, the system may refine the scope of the optimization. Scope refinement includes input from the user regarding the scenario optimization scope. For example, the user may wish to only perform the hypothetical optimization on a specific item, family of products or product area (e.g., cancer drugs, computer equipment, etc.). The scope may also be refined by region or specific market. It may also be filtered by network group, trade route, or by portfolio. Portfolios may be delineated by a given planner, company subsidiary, or other segmentation. After all the definitions have been generated, the system may process these definitions to generate a parameter set for the optimization. After the query has thus been converted to the parameter set, the hypothetical optimization may be performed.

Returning now to FIG. 8, after performing the optimization functions, the presentation may also be defined (at 880). As previously noted, the presentation may be set by the user, or may be auto configured based upon the query and/or optimization results. Presentation parameters may include plotting cost as a function of the variables being altered by the query, plotting service levels achieved as a function of the variables being altered by the query and recommendations of “best value” for the supply chain subject to the query variable changes. “Best value” may be based upon a cost optimization, a service level optimization or a composite of the two. The presentation may also include comparisons of the queried optimization versus the current supply chain. These side-by-side comparisons may include key elements as well as elements that diverge significantly between the two. This avoids information overload by displaying too many datapoints that are immaterial and/or similar between the hypothetical optimization and the currently optimized supply chain. Side-by-side comparison may be a global aggregation of results or more granular (e.g., individual item, SKU, network group, etc.).

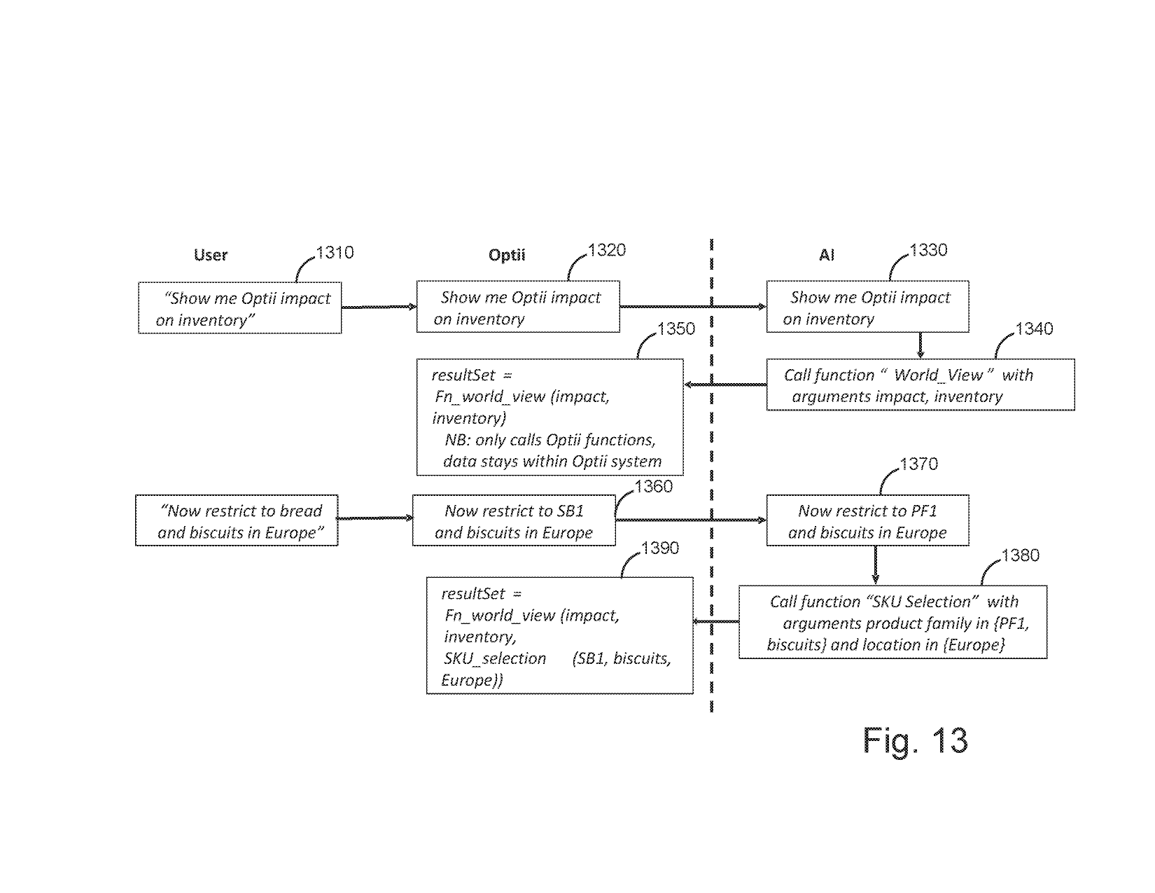

Turning now to FIG. 13, a swim-lane diagram of information flow is presented for one example query. In this example diagram, there are three primary entities, the user/request source, the trusted optimization system (Optii) and the AI request transformation system. The user may generate a natural language query, such as “Show me Optii impact on inventory”, as seen at 1310. The optimization system will consume the query and optionally augment it and remove sensitive information. For this example query, there is no need for either sanitization or augmentation, so the query will be provided, largely unchanged at 1320 to the AI request transformation system. Here, the unaltered query seen at 1330 is transformed into a function and parameter statement “Call function ‘World_View’ with arguments impact, inventory” as seen at 1340. The AI request transformation system is a foundational model that has been trained to generate function and parameter statements for the optimization system. This statement/action is provided back to the optimization system where it is converted into the appropriate APIs and functions for execution. Here this results in the following activities: “resultSet=Fn_world_view (impact, inventory)” as seen at 1350. The results are generated and displayed to the user.

The user may then wish to further refine the inquiry. In this example, the user inputs “Now restrict to bread and biscuits in Europe”. In this hypothetical example, the company is planning on entering the bread market, but this is still non-public confidential information. The term “bread” is listed on a blacklist, and the system does a check, within the trusted environment of the optimization system, of the query against this blacklist. When the term “bread” is found, the query is sterilized to remove the sensitive data, and a placeholder of secret brand 1 (SB1) is used to replace the restricted term. The resulting query states “Now restrict to SB1 and biscuits in Europe” as seen at 1360. This sanitized query is provided to the non-trusted AI system for conversion. The message received by the AI system is to “now restrict to product family 1 (PF1) and biscuits in Europe”, as seen in 1370. Secret brand 1 was converted into a synthetic data of the correct type (e.g., Product Family 1) for the AI system. The AI request transformation system then converts this request into a function and parameter statement/action of “Call function “SKU Selection” with arguments product family in {PF1, biscuits} and location in {Europe}” as seen at 1380. This action is provided back to the optimization system (again a trusted environment), where the synthetic PF1 can be resubstituted with the actual data SB1/Bread. The results of which are calling the API statement “resultSet= Fn_world_view (impact, inventory, SKU_selection (SB1, biscuits, Europe))” as seen at 1390. In this manner, sensitive data is not shared with the AI request transformation system, and yet the sensitive data is reincorporated back into the results within the trusted optimization system.

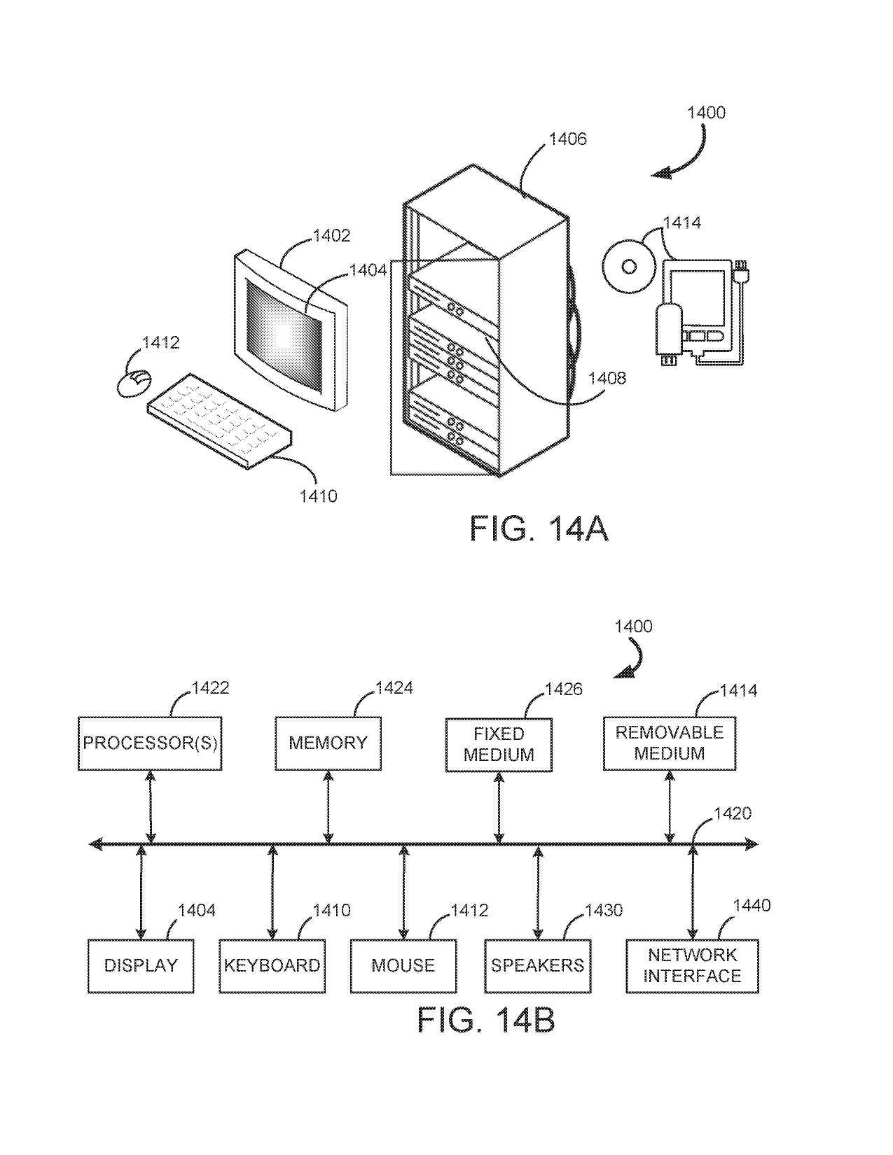

FIGS. 14A and 14B illustrate a Computer System 1400, which is suitable for implementing some embodiments of the present invention. FIG. 14A shows one possible physical form of the Computer System 1400. Of course, the Computer System 1400 may have many physical forms ranging from a printed circuit board, an integrated circuit, and a small handheld device up to a huge supercomputer. Computer system 1400 may include a Monitor 1402, a Display 1404, a Housing 1406, a Disk Drive and or Server Blade 1408, a Keyboard 1410, and a Mouse 1412. External storage 1414 is a computer-readable medium used to transfer data to and from Computer System 1400.

FIG. 14B is an example of a block diagram for Computer System 1400. Attached to System Bus 1420 are a wide variety of subsystems. Processor(s) 1422 (also referred to as central processing units, or CPUs) are coupled to storage devices, including Memory 1424. Memory 1424 includes random access memory (RAM) and read-only memory (ROM). As is well known in the art, ROM acts to transfer data and instructions uni-directionally to the CPU and RAM is used typically to transfer data and instructions in a bi-directional manner. Both of these types of memories may include any suitable of the computer-readable media described below. A Fixed Disk 1426 may also be coupled bi-directionally to the Processor 1422; it provides additional data storage capacity and may also include any of the computer-readable media described below. Fixed Disk 1426 may be used to store programs, data, and the like and is typically a secondary storage medium (such as a hard disk) that is slower than primary storage. It will be appreciated that the information retained within Fixed Disk 1426 may, in appropriate cases, be incorporated in standard fashion as virtual memory in Memory 1424. Removable Storage Medium 1414 may take the form of any of the computer-readable media described below.

Processor 1422 is also coupled to a variety of input/output devices, such as Display 1404, Keyboard 1410, Mouse 1412 and Speakers 1430. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, motion sensors, brain wave readers, or other computers. Processor 1422 optionally may be coupled to another computer or telecommunications network using Network Interface 1440. With such a Network Interface 1440, it is contemplated that the Processor 1422 might receive information from the network or might output information to the network in the course of performing the above-described supply chain optimizations. Furthermore, method embodiments of the present invention may execute solely upon Processor 1422 or may execute over a network such as the Internet in conjunction with a remote CPU that shares a portion of the processing.

In addition, embodiments of the present invention further relate to computer storage products with a computer-readable medium that have computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs or Blu-ray disks and holographic devices; magneto-optical media such as floppy or optical disks; and hardware devices that are specially configured to store and execute program code, such as application-specific integrated circuits (ASICs), programmable logic devices (PLDs) and ROM and RAM devices such as USB memory sticks. Examples of computer code include machine code, such as produced by a compiler, and files containing higher level code that are executed by a computer using an interpreter.

While this invention has been described in terms of several embodiments, there are alterations, modifications, permutations, and substitute equivalents, which fall within the scope of this invention. Although sub-section titles have been provided to aid in the description of the invention, these titles are merely illustrative and are not intended to limit the scope of the present invention. In addition, where claim limitations have been identified, for example, by a numeral or letter, they are not intended to imply any specific sequence.

It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

What is claimed is:

1. A computerized method for query based analysis of optimization of a supply chain, the method comprising:
receiving a query within a trusted environment of an optimization system, wherein the query includes a natural language expression;
supplying the query to an Artificial Intelligence (AI) transformation system, wherein the AI transformation system converts the query into a function and parameter statement;
receiving the function and parameter statement from the AI transformation system;
translating the function and parameter statement into at least one API call and function;
executing the at least one API call and function to generate results; and
outputting the results.

2. The method of claim 1, wherein the AI transformation system is locally trained on the optimization system.

3. The method of claim 1, further comprising augmenting the query with information.

4. The method of claim 3, wherein the information includes at least one of query source information and query intent information.

5. The method of claim 1, further comprising identifying sensitive data in the query.

6. The method of claim 5, wherein the sensitive information is identified by blacklist, whitelist or semantic analysis.

7. The method of claim 5, further comprising replacing, at the optimization system, the sensitive information with a synthetic placeholder prior to sending the query to the AI transformation system.

8. The method of claim 7, further comprising reintegrating the sensitive information into the function and parameter statement in the optimization system.

9. The method of claim 1, wherein the AI transformation system includes a foundational model.

10. The method of claim 1, wherein the at least one API call and function includes a hypothetical supply chain optimization.

11. A computerized system for query-based analysis of optimization of a supply chain, the system comprising:
a trusted environment of an optimization system for receiving a query, wherein the query includes a natural language expression; and
an Artificial Intelligence (AI) transformation system for receiving the query, wherein the AI transformation system converts the query into a function and parameter statement, and for receiving the function and parameter statement from the AI transformation system, and for translating the function and parameter statement into at least one API call and function, and for executing the at least one API call and function to generate results, and for outputting the results.

12. The system of claim 11, wherein the AI transformation system is locally trained on the optimization system.

13. The system of claim 11, wherein the AI transformation system further augments the query with information.

14. The system of claim 13, wherein the information includes at least one of query source information and query intent information.

15. The system of claim 11, wherein the AI transformation system further identifies sensitive data in the query.

16. The system of claim 15, wherein the sensitive information is identified by blacklist, whitelist or semantic analysis.

17. The system of claim 15, wherein the optimization system further replaces the sensitive information with a synthetic placeholder prior to sending the query to the AI transformation system.

18. The system of claim 17, wherein the AI transformation system further reintegrates the sensitive information into the function and parameter statement in the optimization system.

19. The system of claim 11, wherein the AI transformation system includes a foundational model.

20. The system of claim 11, wherein the at least one API call and function includes a hypothetical supply chain optimization.
